(19) United States
(12) Patent Application Publication
(10) Pub. No.: US 2004/0224744 A1
(43) Pub. Date: Nov. 11, 2004

(54) Game machine and control program therefor

(75) Inventors: Kazunobu Sato, Tokyo (JP); Junichi Kogo, Tokyo (JP)

Correspondence Address: Ronald R. Snider, P.O. Box 27613, Washington, DC, 20038-7613, US

(73) Assignee: Aruze Corporation, Tokyo (JP)

(21) Appl. No.: 10/835,335

(22) Filed: Apr. 30, 2004

(30) Foreign Application Priority Data
May 9, 2003 (JP) 2003-132177
May 9, 2003 (JP) 2003-132178
May 9, 2003 (JP) 2003-132179
May 9, 2003 (JP) 2003-132180

(51) Int. Cl. A63F 13/00

(52) U.S. Cl. 463/11

(57) ABSTRACT

A mahjong game machine (10) has a display device (13) which displays at least a tile owned by a player and a tile discarded thereby and a tile discarded by an opponent character (A to E); a game control device (30) which proceeds with a mahjong game according to a control signal from an operating device (15); a selecting device (30) which selects, according to a playing result against an opponent character, an attraction data item from stored data; and an attraction device (30) which presents an attraction according to thus selected attraction data item.

### RELATED APPLICATIONS

This application claims the priorities of Japanese Patent Application Nos. 2003-132177, 2003-132178, 2003-132179, and 2003-132180 filed on May 9, 2003, which are incorporated herein by reference.

### BACKGROUND OF THE INVENTION

1. Field of the Invention

The present invention relates to a game machine which provides a confrontation game and a control program for a game machine. In particular, the present invention relates to a mahjong game machine for providing a mahjong game and a control program for a mahjong game machine.

2. Description of the Prior Art

Mahjong game machines which provide a two-player mahjong game to play against an opponent character have been known (see, for example, Japanese Unexamined Utility Model Publication No. HEI 4-70089). Such a mahjong game machine causes its display to show images indicating a player's own tiles and discarded tiles, an opponent character's discarded tiles, and the like, whereas a mahjong game proceeds while the player and opponent character repeatedly draw and discard tiles. The player assembles own tiles in order to complete a hand, and can attain from the opponent character a point corresponding to a hand competed by a combination of own tiles when the hand is completed earlier than by the opponent character. If the player wins over the opponent character by reducing the opponent character's point to zero and so forth, an attraction such as praise for the mahjong skill of the player is presented on the display, for example. As the point of the opponent character is reduced, the point of the player increases.

However, the attraction presented when the player wins over an opponent character is determined beforehand for each opponent character, whereby the player may be bored with such a monotonous attraction after playing a number of mahjong games, and with the mahjong games themselves after repeating the games.

When the point of the opponent character is reduced to zero, an ending attraction to be done in response to the winning over the opponent character is presented in the above-mentioned game machine. The ending attraction is determined beforehand for each opponent character or uniformly presented for a plurality of opponent characters, whereby the player may be bored with such a monotonous attraction after playing a number of mahjong games, and with the mahjong games themselves after repeating the games.

In many mahjong game machines, on the other hand, a confrontation game is terminated when a preset point is lost in a mahjong game played against an opponent character, whereas the game is won by the player when the point owned by the opponent character is lost, and then a game against the next opponent character is started. For the next opponent character, different kinds of opponent characters are displayed in an order preset in storage means provided in each mahjong game machine. The storage means stores image data such as a plurality of kinds of opponent character images, tile images, and background images, game program data for proceeding with a game, sound data to be reproduced during the game, and the like, whereas the next opponent character is uniformly determined according to details of the game program data.

When the player wins over the opponent character in the conventional mahjong game machines, whether the winning by a large margin with a big completed hand or by a narrow margin with a small completed hand, the kind of the next opponent character is set beforehand regardless of the result of each game. Games are monotonously consumed so as to play against opponent characters in the fixed order. Therefore, when a plurality of games are played in succession, patterns of playing with the opponent characters can be expected to a certain extent, whereby the player is likely to be bored with the games and lose interest therein.

### SUMMARY OF THE INVENTION

In view of the problems mentioned above, it is an object of the present invention to provide a confrontation game machine with which the player can fully enjoy games without being bored because of various attractions, and a control program therefor, such as a mahjong game machine and a control program therefor in particular.

It is another object of the present invention to provide a game machine which does not display opponent characters in a predetermined order so as to form a fixed flow of the game, but can allow the player to play a confrontation game continuously and enjoyably without being bored immediately after playing the game a plurality of times and provide a quite amusing game, and a control program therefor, such as a mahjong game machine and a control program therefor in particular.

The present invention provides a confrontation game machine with which a player plays against a character in a game,

the game machine comprising:

storage means for storing a plurality of items of attraction data concerning attractions presented in response to a win over the character and/or data specifying a plurality of characters to play against in the game;

display means for displaying an opponent character stored in the storage means; and

selecting means for selecting one item of attraction data from the plurality of items of attraction data stored in the storage means and/or selecting in an order of playing against the player the data specifying the plurality of characters stored in the storage means.

The present invention provides a mahjong game machine comprising:

display means for displaying at least images of a tile owned by a player and a tile discarded thereby and a tile discarded by an opponent character played against in a game;

game control means for proceeding with a mahjong game according to at least a control signal from operating means;

attraction data storage means for storing a plurality of items of attraction data associated with a result of winning/losing of the game;

selecting means for selecting according to the result of winning/losing of the game one item of attraction data from the plurality of items of attraction data stored in the attraction data storage means; and

attraction means for causing the display means to carry out an attraction at least with an image according to the item of attraction data selected by the selecting means.

The present invention provides a mahjong game machine which provides a mahjong game in which a player plays against a plurality of opponent characters in a game, the game machine comprising:

display means for displaying at least images of a tile owned by a player and a tile discarded thereby and a tile discarded by the opponent characters;

game control means for proceeding with a mahjong game according to at least a control signal from operating means;

attraction data storage means for storing a plurality of items of attraction data concerning attractions presented in response to wins over the opponent characters;

selecting means for selecting according to a result of playing against an opponent character in response to a win over the opponent character one item of attraction data from the plurality of items of attraction data stored in the attraction data storage means; and

attraction means for presenting an attraction based on an image and/or sound according to the item of attraction data selected by the selecting means.

The mahjong game may be a two-player mahjong game played by two players in one game.

The attraction data may include a plurality of items of ending attraction data concerning a plurality of ending attractions presented in response to wins over all the plurality of opponent characters, whereas the selecting means may select one item of ending attraction data from the plurality of items of ending attraction data in response to wins over all the plurality of opponent characters.

The present invention provides a mahjong game machine control program which causes a mahjong game machine comprising display means for displaying at least images of a tile owned by a player and a tile discarded thereby and a tile discarded by an opponent character and providing a two-player mahjong game in which a player plays against a plurality of opponent characters to function as:

game control means for proceeding with the mahjong game according to at least a control signal from operating means;

attraction data storage means for storing a plurality of items of attraction data concerning attractions presented in response to wins over the opponent characters;

selecting means for selecting according to a result of playing against an opponent character in response to a win over the opponent character one item of attraction data from the plurality of items of attraction data stored in the attraction data storage means; and

attraction means for presenting an attraction based on an image and/or sound according to the item of attraction data selected by the selecting means.

The attraction data may include a plurality of items of ending attraction data concerning a plurality of ending attractions presented in response to wins over all the plurality of opponent characters, whereas the selecting means may select one item of ending attraction data from the plurality of items of ending attraction data in response to wins over all the plurality of opponent characters.

The present invention provides a mahjong game machine comprising:

display means for displaying at least images of a tile owned by a player and a tile discarded thereby and a tile discarded by an opponent character played against in a game;

game control means for executing a game program concerning a mahjong game according to a control signal from operating means operated by the player and for calculating a result of winning/losing of the mahjong game;

attraction data storage means for storing a plurality of items of attraction data associated with results of winning/losing by the game control means;

selecting means for selecting according to the result of winning/losing calculated by the game control means one item of attraction data from the plurality of items of attraction data stored in the attraction data storage means; and

attraction means for causing the display means to present an attraction by an image according to the item of attraction data selected by the selecting means.

The result of winning/losing may be a result of playing against a plurality of opponent characters played against in a game,

whereas the mahjong game machine may comprise playing result storage means for cumulatively storing the result of playing as playing result data from when any of the player and the opponent characters completes a hand, and

the selecting means may extract, according to a plurality of items of results of playing cumulatively stored in the playing result storage means, an item of attraction data which displays a specific character in the plurality of characters, and causes the display means to display the specific character.

The mahjong game machine may further comprise point calculating means for carrying out a subtraction or addition of points of the player or opponent characters according to the result of winning/losing. From when the points calculated by the point calculating means becomes minus, the selecting means may select the attraction data, and the attraction means may display and execute an ending attraction.

The present invention provides a mahjong game machine control program which causes a mahjong game machine comprising display means for displaying at least images of a tile owned by a player and a tile discarded thereby and a tile discarded by an opponent character played against in a game to function as:

game control means for executing a game program concerning a mahjong game according to a control signal from operating means operated by the player and calculating a result of winning/losing of the mahjong game;

attraction data storage means for storing a plurality of items of attraction data associated with the result of winning/losing calculated by the game control means;

selecting means for selecting according to the result of winning/losing calculated by the game control means one item of attraction data from the plurality of attraction data stored in the attraction data storage means; and

attraction means for presenting an attraction based on an image and/or sound according to the item of attraction data selected by the selecting means.

The result of winning/losing may be a result of playing against a plurality of opponent characters to play against in a game,

whereas the mahjong game machine control program may function as playing result storage means for cumulatively storing the result of playing as playing result data from when any of the player and the opponent characters completes a hand, and

function, according to a plurality of items of results of playing cumulatively stored in the playing result storage means, to cause the selecting means to extract an item of attraction data which displays a specific character in the plurality of characters, and cause the display means to display the specific character.

The mahjong game machine control program may function as point calculating means for carrying out a subtraction or addition of a point of the player or opponent characters according to the result of winning/losing. From when the point calculated by the point calculating means becomes minus, the selecting means may function to select the attraction data, and the attraction means may function to display and execute an ending attraction.

The present invention provides a game machine comprising:

storage means for storing at least a plurality of items of data specifying a plurality of opponent characters to play against in a game;

display means for displaying the opponent characters stored in the storage means; and

selecting means for selecting as an operation of determining an order of playing with the player the data specifying the plurality of characters stored in the storage means.

The present invention provides a game machine comprising:

storage means for storing a plurality of species of image data of opponent characters to play against in a game, and results of playing against the opponent characters classified into a plurality of evaluation levels beforehand;

display means for displaying an opponent character stored in the storage means;

operating means for inputting an instruction from the player during a play against the opponent character displayed by the display means;

display control means for successively displaying on the display means the opponent characters replaced according to the evaluation level based on the results of playing;

temporary storage means for temporarily storing data of the result of playing against the opponent character by the player;

comparing means for comparing the result of playing temporarily stored in the temporary storage means with the evaluation levels stored in the storage means; and

selecting means for selecting from the plurality of types of opponent characters an opponent character to be displayed as a replacement on the display means according to a result of comparison by the comparing means.

The game machine may be a mahjong game machine.

The present invention provides a game machine control program for causing a game machine comprising display control means for successively displaying on display means a plurality of types of opponent characters to play against in a game replaced according to an evaluation level based on a result of playing, and temporary storage means for temporarily storing a result of playing against an opponent character by a player to function as

comparing means for comparing the result of playing temporarily stored in the temporary storage means with the evaluation level stored in the storage means; and

selecting means for selecting from the plurality of types of opponent characters an opponent character to be displayed as a replacement on the display means according to a result of comparison by the comparing means.

The present invention provides a mahjong game machine providing a mahjong game in which a player can successively play against a plurality of opponent characters and comprising:

display means for displaying at least images of a tile owned by the player and a tile discarded thereby and a tile discarded by an opponent character played against in the game; and

opponent character sampling means for determining by sampling an order of playing against the plurality of opponent characters.

In this mahjong game machine, the opponent character sampling means may determine an opponent from remaining unplayed opponent characters at each match.

The mahjong game machine may further comprise character garment sampling means which can cause the display means to display the plurality of opponent characters as a plurality of images with different garments, respectively, and determines by sampling which opponent character with a garment to display.

The present invention provides a mahjong game machine control program which causes a mahjong game machine providing a mahjong game in which a player can successively play against a plurality of opponent characters and comprising display means for displaying at least images of a tile owned by the player and a tile discarded thereby and a tile discarded by an opponent character played against in the game to function as

opponent character sampling means for determining by sampling an order of playing against the plurality of opponent characters.

### BRIEF DESCRIPTION OF THE DRAWINGS

FIG. 1 is a perspective view showing an example of the mahjong game machine in accordance with a first embodiment of the present invention;

FIG. 2 is a plan view schematically showing an operating board 14 in the mahjong game machine shown in FIG. 1;

FIG. 3 is a block diagram schematically showing the inner configuration of the mahjong game machine shown in FIG. 1;

FIG. 4 is a flowchart showing a subroutine executed in the mahjong game shown in FIG. 1;

FIG. 5 is a flowchart showing a first attraction selecting routine executed as being called at step S11 and the like of the subroutine shown in FIG. 4;

FIGS. 6A to 6C are views schematically showing examples of images displayed on the display device of the mahjong game machine shown in FIG. 1;

FIG. 7 is a flowchart showing a second attraction selecting routine executed as being called at step S18 and the like of the subroutine shown in FIG. 4;

FIG. 8 is a flowchart showing the favorability setting routine executed as being called at step S51 of the subroutine shown in FIG. 7;

FIG. 9 is a flowchart showing the favorability setting routine executed as being called at step S51 of the subroutine shown in FIG. 7;

FIG. 10 is a flowchart showing the favorability setting routine executed as being called at step S51 of the subroutine shown in FIG. 7;

FIGS. 11A to 11C are views schematically showing examples of images displayed on the display device of the mahjong game machine shown in FIG. 1;

FIG. 12 is a flowchart showing an ending routine executed as being called at step S27 of the subroutine shown in FIG. 4;

FIGS. 13A and 13B are views schematically showing examples of images displayed on the display device of the mahjong game machine shown in FIG. 1;

FIG. 14 is a block diagram schematically showing an example of the mahjong game machine in accordance with a second embodiment of the present invention;

FIG. 15 is a functional block diagram of a control unit in the mahjong game machine shown in FIG. 14;

FIG. 16 is a block diagram schematically showing an example of the mahjong game machine in accordance with a third embodiment of the present invention;

FIG. 17 is a view showing opponent character playing order patterns stored in a ROM in the mahjong game machine shown in FIG. 16;

FIG. 18 is a block diagram schematically showing an example of the mahjong game machine in accordance with a fourth embodiment of the present invention;

FIG. 19 is a flowchart showing an example of subroutine executed in the mahjong game machine shown in FIG. 18;

FIG. 20 is a flowchart showing an ending routine executed as being called at step S324 of the subroutine shown in FIG. 19;

FIG. 21 is a flowchart showing a subroutine different from that shown in FIG. 19; and

FIG. 22 is an opponent character playing order sampling table used in step S390 of the subroutine shown in FIG. 21.

### DESCRIPTION OF THE PREFERRED EMBODIMENTS

In the following, embodiments of the present invention will be explained with reference to the drawings.

### First Embodiment

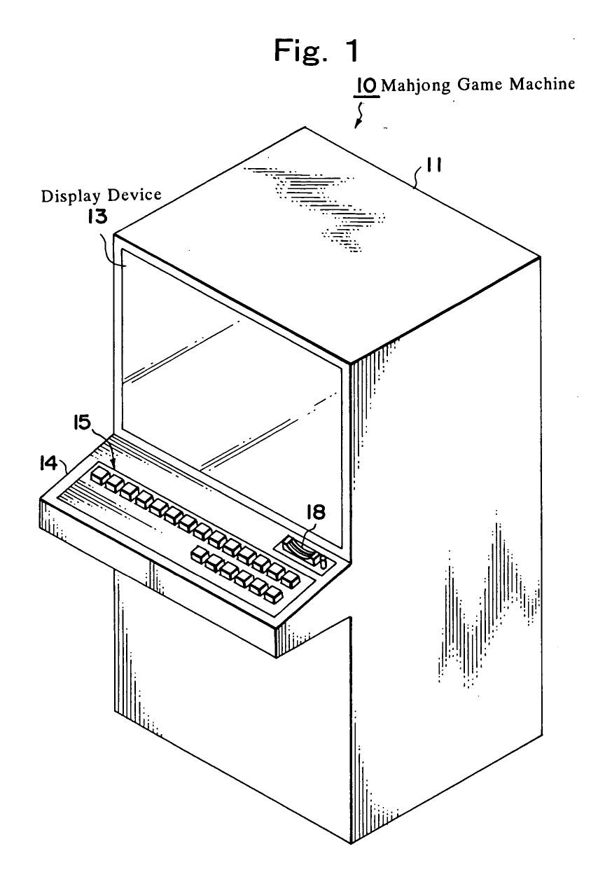

FIG. 1 is a perspective view schematically showing an example of the mahjong game machine in accordance with a first embodiment. Though the mahjong game machine shown in FIG. 1 is an arcade game machine placed in a so-called arcade, the mahjong game machine in accordance with the present invention encompasses not only arcade game machines but also home game machines and portable game machines, for example.

The mahjong game machine 10 comprises a vertically long box-shaped housing 11 with a display device 13 attached to the upper side of the housing 11. The display device 13 displays images indicating 13 or 14 tiles owned by a player, tiles discarded by the player, tiles owned by an opponent character in a mode directed to the backside, tiles discarded by the opponent character, and the like. The display device 13 further displays images indicating the player playing the mahjong game, the opponent character, and the like.

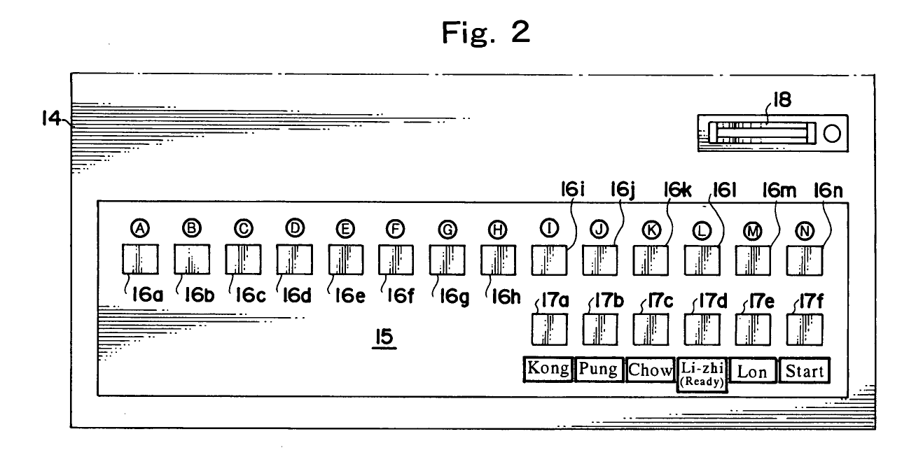

On the lower side of the display device 13, an operating board 14 provided with an operating device 15 is disposed so as to project to the front side. The operating device 15 comprises 14 operating buttons disposed on the rear side of the operating board 14 and 6 operating buttons disposed on the front side thereof. By manipulating the operating buttons of the operating device 15, the player can carry out various operations related to the mahjong game. The operating device 15 will later be explained in detail with reference to FIG. 2.

At the right end on the rear side of the operating board 14, a coin insertion slot 18 for inserting a coin necessary for starting the mahjong game is formed.

FIG. 2 is a plan view schematically showing the operating board 14 of the mahjong game machine 10. As shown in FIG. 2, the operating device 15 in the operating board 14 comprises 14 operating buttons 16 (16a to 16n) disposed on the upper side (rear side in FIG. 1) of the operating board 14 and 6 operating buttons 17 (17a to 17f) disposed on the lower side (front side in FIG. 1). The coin insertion slot 18 is formed on the upper right side of the 14 operating buttons 16.

The 14 operating buttons 16 (16a to 16n) correspond to 14 tiles which are those owned by the player displayed on the display device 13, respectively. Pushing the operating button 16n when the number of tiles owned by the player is 13 draws a tile, thereby displaying a new tile at the right end (position corresponding to the operating button 16n) of the 13 tiles displayed on the display device 13, thus increasing the number of tiles owned by the player to 14. Then, the player chooses 1 unnecessary tile from the 14 tiles owned thereby and pushes the operating button corresponding to this tile, so as to discard the tile. As a result, the unnecessary tile is erased from the tiles owned by the player, which reduces the number of tiles owned by the player to 13 and newly displays the discarded unnecessary tile in a part of the display device 13 indicating discarded tiles.

In the six operating buttons 17 (17a to 17f), the operating buttons 17a to 17e correspond to actions of “Kong”, “Pung”, “Chow”, “Li-zhi (Ready)”, and “Lon” in the conventional mahjong, respectively, whereas the operating button 17f is a button pushed for starting the mahjong game after inserting a coin into the coin insertion slot 18.

By operating the operating device 15 comprising the operating buttons 16a to 16n and 17a to 17f, the player successively changes tiles owned thereby. On the other hand, the opponent character carries out similar actions, which are automatically controlled by a control unit (CPU). As a matter of course, tiles of the opponent character are displayed in a mode directed to the backside, so that the player can see only the tiles discarded by the opponent character.

The player and opponent character repeatedly draw and discard tiles in an alternating fashion with actions of “Pung”, “Chow”, and the like inserted as the case may be. When the tiles owned by the player becomes a set corresponding to any of a plurality of hands (e.g., “no-points” or “all simples”), the player completes a hand, and the point corresponding to the completed hand can be acquired from the opponent character.

When the opponent character wins by completing a hand, by contrast, the point corresponding to the completed hand is acquired by the opponent character, whereby the point of the player decreases.

Though the player successively changes owned tiles by manipulating the operating buttons in this embodiment, the mahjong game machine of the present invention may be configured such that displays corresponding to the operating buttons are shown on the screen of the display device in order for the above-mentioned operations to be carried out when their corresponding parts are clicked. Alternatively, the machine may be configured such that the above-mentioned operations can be carried out when parts showing tiles are clicked.

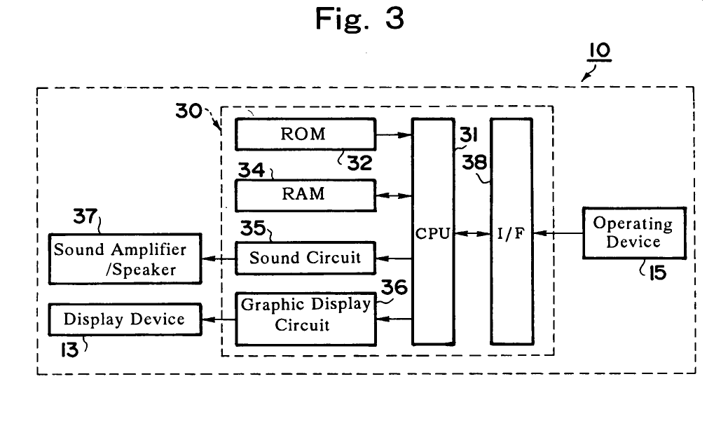

FIG. 3 is a block diagram schematically showing the inner configuration of the mahjong game machine 10.

As shown in FIG. 3, a control unit 30 is disposed within the housing 11 of the mahjong game machine 10. The control unit 30 comprises a CPU (central processing unit) 31, a ROM (Read-Only Memory) 32 as storage means, and a RAM (Random Access Memory) 34 as temporary storage means.

The CPU 31 is connected to the operating device 15 by way of an interface circuit (I/F) 38. By carrying out various processes according to control signals from the operating device 15, the CPU 31 proceeds with the mahjong game.

The ROM 32 stores various kinds of image data such as image data of tiles and opponent characters displayed on the display device 13, and a mahjong game machine control program for regulating the total flow of the mahjong game. The ROM 32 also stores a plurality of items of usual attraction data as attraction data for each opponent character. The usual attraction data include image data, sound data, and the like for presenting usual attractions to be presented in response to the winning over the opponent characters. The ROM 32 further stores a plurality of items of ending attraction data as attraction data. The ending attraction data include image data, sound data, and the like for presenting ending attractions to be presented in response to the winning over all the plurality of opponent characters.

The sound data are not restricted in particular, and may be data of voices such as talks, cries, and exclamations of people, and music, which may be used in combination. The image of each opponent character may represent the whole body or a part thereof such as a face. The attractions may be carried out with one or both of image and sound. In the following, data may also be referred to as voice data, since the present invention mainly uses voice data such as speeches of people.

The ROM 32 functions as attraction data storage means which stores attraction data such as usual attraction data concerning usual attractions and ending attraction data concerning ending attractions.

The RAM 34 stores playing result data. The playing result data include information concerning winning/losing in matches against the opponent characters, points acquired by the player in matches against the opponent characters, the number of completions by the opponent characters, and the like.

A sound circuit 35 is connected to a sound amplifier 37 which outputs various voices corresponding to states of proceeding with the mahjong game. A graphic display circuit 36 causes the display device 13 to display an image selected according to a control signal from the CPU 31.

An example of mahjong game played with the mahjong game machine 10 will now be explained in detail.

(A) Game Rule

The player successively plays mahjong against 5 opponent characters (characters A to E). When the player wins over all the 5 opponent characters, the game ends, whereby ending attractions which will be explained later are provided. If a favorability which will be explained later falls within a predetermined condition at the time when the matches against the characters A to C end, a second match with the characters A to C is carried out. In this case, 2 matches are played for each of the characters A to C, and then a match with each of the characters D and E, thus yielding 8 matches in total.

Each of the player and opponent characters owns a predetermined point (e.g., 10,000) at the time of starting matches. If the point of an opponent character becomes zero or the player completes a hand 3 times, the player wins. If the point of the player becomes zero because the opponent character completes a hand and so forth, by contrast, the game will be over.

(B) Favorability and Usual Attractions

When the player wins over an opponent character, the favorability of the opponent character with respect to the player is set in 3 (high, middle, and low) stages according to the result of playing, and usual attractions are presented according to thus set favorability. In the usual attractions, states in which the opponent character speaks various lines are displayed on the display device 13 according to the favorability of the opponent character.

(C) Ending Attractions

When the player wins over all the 5 opponent characters, ending attractions corresponding to the results of matches against the 5 opponent characters are presented. In the ending attractions, according to the favorability set for each of the 5 opponent characters, an image showing a 2-shot picture with one of the 5 opponent characters or a group picture of all the 5 characters and the player is displayed on the display device 13.

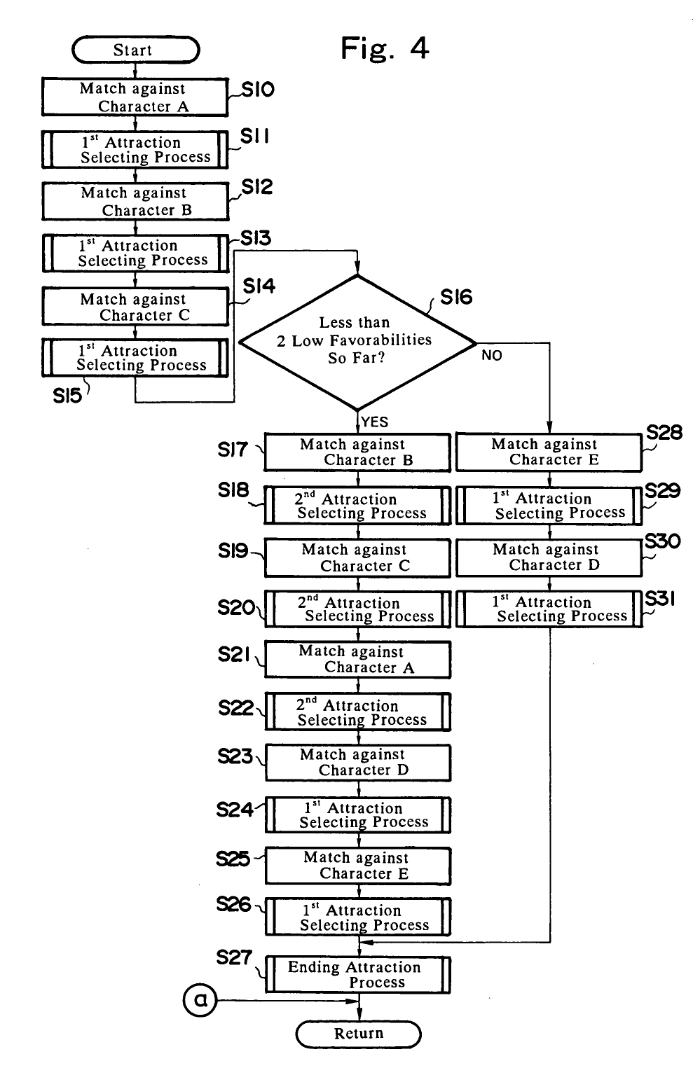

FIG. 4 is a flowchart showing a subroutine executed in the mahjong game machine 10. This subroutine is one executed as being called from a mahjong game machine control program executed beforehand for controlling the mahjong game of the mahjong game machine 10 when the player inserts a predetermined coin into the coin insertion slot 18 and pushes the operating button 17f of the operating device 15.

First, the CPU 31 carries out a process concerning a match against the character A (step S10). When the process of step S10 is executed, the mahjong game proceeds in the above-mentioned procedure, so that a match from when 13 or 14 tiles to become initial tiles owned by the player are supplied (from the distributing of tiles) to when it is determined that the player or the opponent character (character A) completes a hand or none completes a hand (no hand is completed) is repeated until the point of the player or opponent character becomes zero or the player completes a hand 3 times.

In the process of step S10, playing result data including information concerning winning/losing in the match against the opponent character by the player, the point acquired by the player, and the number of completions by the opponent character are stored into the RAM 34.

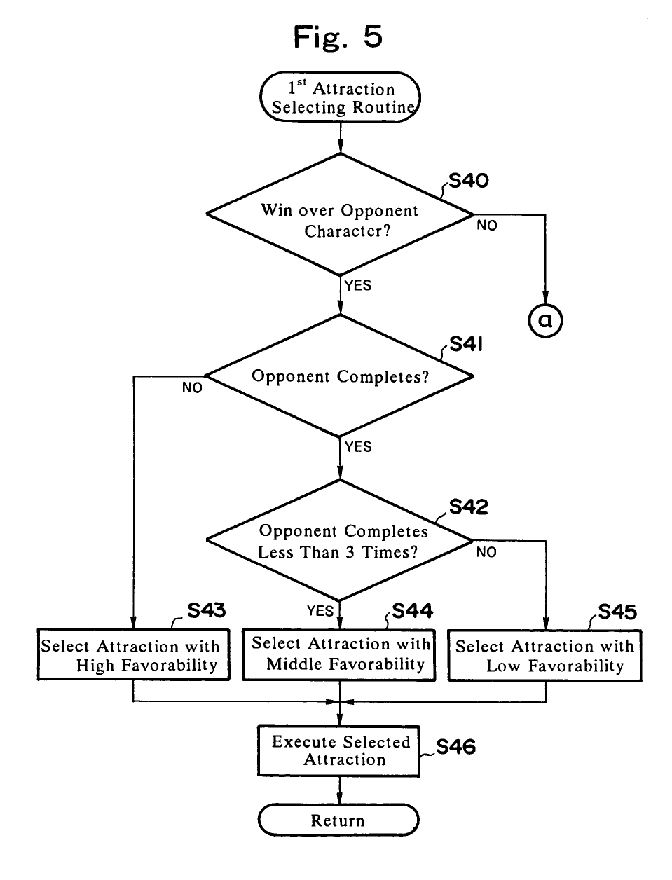

After the process of step S10, the CPU 31 executes a first attraction selecting process (step S11). In the first attraction selecting process, it is determined whether the player wins over the opponent character (character A) or not. If the player wins, the favorability is set in 3 (high, middle, and low) stages according to the number of completions of the opponent character in the match. The favorability data concerning thus set favorability is stored into the RAM 34, and usual attractions are presented according to the favorability data stored in the RAM 34. The first attraction selecting process will later be explained in detail with reference to FIG. 5.

After the process of step S11, the CPU 31 executes a process concerning the playing with the character B (step S12). The process of step S12 is substantially the same as that of step 10 except that the opponent character is the character B instead of the character A and that they differ from each other in terms of the point of the opponent character and the difficulty in the play, and thus will not be explained. Also, processes concerning characters A to E in steps S14, S17, S19, S21, S23, S25, S28, and S30 which will be explained later are substantially the same as the above-mentioned process of step S10 except that different opponent characters are used, and thus will not be explained in the following. While actions of the characters A to E are regulated by the control unit, mahjong skills of the characters A to E are set for the respective opponent characters, whereby the difficulty for the player to complete a hand and the like may vary depending on the opponent characters.

After the process of step S12, the CPU 31 executes the first attraction selecting process (step S13).

In the first attraction selecting process, as in the case of step S11, it is determined whether the player wins over the character B or not. If the player wins, the favorability is set in 3 (high, middle, and low) stages according to the number of completions of the opponent character in the play. The favorability data concerning thus set favorability is stored into the RAM 34, and usual attractions are presented according to the favorability data stored in the RAM 34.

Here, conforming to the fact that the opponent character is replaced by the character B, usual attractions different from those in step S11 are presented even at the same favorability (e.g., high favorability). For reducing the data volume, the same usual attractions may be carried out when the favorability is the same after changing the character.

In the first attraction selecting processes in steps S15, S24, S26, S29, and S31 which will be explained later, their opponent characters differ from that in step S11, whereby usual attractions different from those in step S11 are presented even at the same favorability (e.g., high favorability). However, their processing methods are substantially the same as those of steps S11, S13 mentioned above, and thus will not be explained in the following.

After the process of step S13, the CPU 31 executes a process concerning a match against the character C (step S14) and then the first attraction selecting process (step S15).

After the process of step S15, the CPU 31 determines whether the number of low favorabilities set as a result of the playing with the 3 opponent characters A to C is less than 2 or not (step S16). Namely, the CPU 31 refers to the respective favorability data items concerning the characters A to C stored in the RAM 34, and determines whether the number of opponent characters set to the low favorability is less than 2 or not.

When it is determined in step S16 that the number of low favorabilities set is less than 2, the CPU 31 executes a process concerning a match against the character B (step S17). The process of step S17 causes the player to play a second match against the character B.

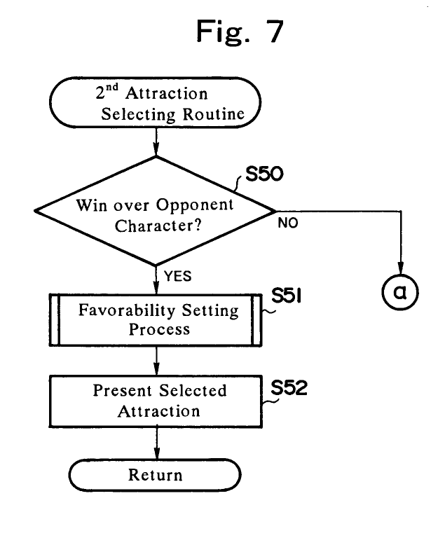

After the process of step S17, the CPU 31 executes the second attraction selecting process (step S18). In the second attraction selecting process, it is determined whether the player wins the second match against the opponent character or not. If the player wins against the opponent character, the favorability is set in 3 (high, middle, and low) stages according to the point of the player after the second match and the favorability of the opponent character in the first match, the favorability data concerning thus set favorability is stored into the RAM 34, and usual attractions are represented according to the favorability stored in the RAM 34. The second attraction selecting process will later be explained in detail with reference to FIG. 7.

After the process of step S18, the CPU 31 executes a process concerning the second match against the character C (step S19), and then the second attraction selecting process (step S20).

In the second attraction selecting process in step S20, since the opponent character differs from that in the case of S17, usual attractions different from those in step S17 are presented even at the same favorability (e.g., high favorability). However, the processing method is substantially the same as that in the above-mentioned process of step S17, and thus will not be explained. The same holds in the following step S22.

Subsequently, the CPU 31 executes a process concerning the second match against the character A (step S21), and then the second attraction selecting process (step S22).

After the process of step S22, the CPU 31 executes a process concerning a match against the character D (step S23), the first attraction selecting process (step S24), a process concerning a match against the character E (step S25), and then the first attraction selecting process (step S26).

If it is determined in the above-mentioned step S16 that the number of low favorabilities set is not less than 2 (i.e., is at least 2), the CPU 31 executes a process concerning a match against the character E (step S28), the first attraction selecting process (step S29), a process concerning a match against the character D (step S30), and then the first attraction selecting process (step S31).

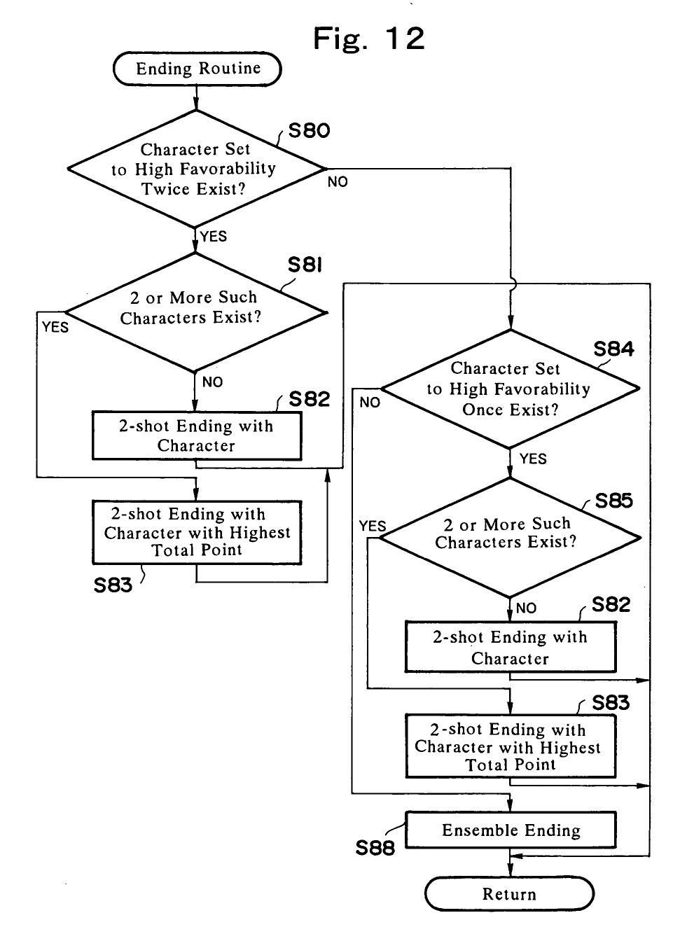

After executing the process of step S26 or S31, the CPU 31 carries out an ending attraction process (step S27). In the ending process, an image showing a 2-shot picture with one of the 5 opponent characters or a group picture of all the 5 characters and the player is displayed on the display device 13. The ending attraction process will later be explained in detail with reference to FIG. 12.

After executing the process of step S27, this subroutine is terminated.

During when the subroutine shown in FIG. 4 is executed, the control unit 30 functions as game control means which proceeds with the mahjong game according to a control signal from the operating device 15.

FIG. 5 is a flowchart showing the first attraction selecting routine executed as being called at steps S11, S13, S15, S24, S26, S29, and S31 of the subroutine shown in FIG. 4.

First, the CPU 31 determines whether the player wins against the opponent character or not (step S40). Namely, referring to the playing result data stored in the RAM 34, the CPU 31 determines whether or not information indicating the winning of the player exists in the playing result data as a result of the match against the opponent character in the above-mentioned process of step S10, S12, S14, S23, S25, S28, or S30.

If it is determined in step S40 that the player does not win over the opponent character (i.e., is defeated by the opponent character), the CPU 31 ends the subroutine shown in FIG. 1. Here, the player is defeated, and the game is over.

If it is determined in step S40 that the player wins over the opponent character, then the CPU 31 determines whether the opponent (opponent character) completes a hand or not (step S41). Namely, referring to the playing result data stored in the RAM 34, the CPU 31 determines whether the number of completions by the opponent character is at least 1 or not.

If it is determined in step S41 that the opponent completes no hand, then the CPU 31 selects attractions with a high favorability (step S43). Namely, the CPU 31 sets the favorability of the opponent character as high, stores the favorability data concerning thus set favorability into the RAM 34, selects a usual attraction data item corresponding to the high favorability from a plurality of usual attraction data items stored in the ROM 32, and sets thus selected data item into the RAM 34. The favorability data vary among the opponent characters even at the same favorability. The same holds in the following. The same data may be used at the same favorability as well.

If it is determined in step S41 that the opponent completes a hand, then the CPU 31 determines whether the number of completions by the opponent is less than 3 or not (step S42). Namely, referring to the playing result data stored in the RAM 34, the CPU 31 determines whether the number of completions by the opponent character is less than 3 or not.

If it is determined in step S42 that the number of completions by the opponent is less than 3, then the CPU 31 selects attractions with a middle favorability (step S44). Namely, the CPU 31 sets the favorability of the opponent character as middle, stores the favorability data concerning thus set favorability into the RAM 34, selects a usual attraction data item corresponding to the middle favorability from a plurality of usual attraction data items stored in the ROM 32, and sets thus selected data item into the RAM 34.

If it is determined in step S42 that the number of completions by the opponent is not less than 3 (i.e., is at least 3), by contrast, then the CPU 31 selects attractions with a low favorability (step S45). Namely, the CPU 31 sets the favorability of the opponent character as low, stores the favorability data concerning thus set favorability into the RAM 34, selects a usual attraction data item corresponding to the low favorability from a plurality of usual attraction data items stored in the ROM 32, and sets thus selected data item into the RAM 34.

After any of the processes of steps S43 to S45, the CPU 31 executes the selected attractions (step S46). Namely, the CPU 31 presents usual attractions according to the usual attraction data selected in any of the processes of steps S43 to S45 and set in the RAM 34.

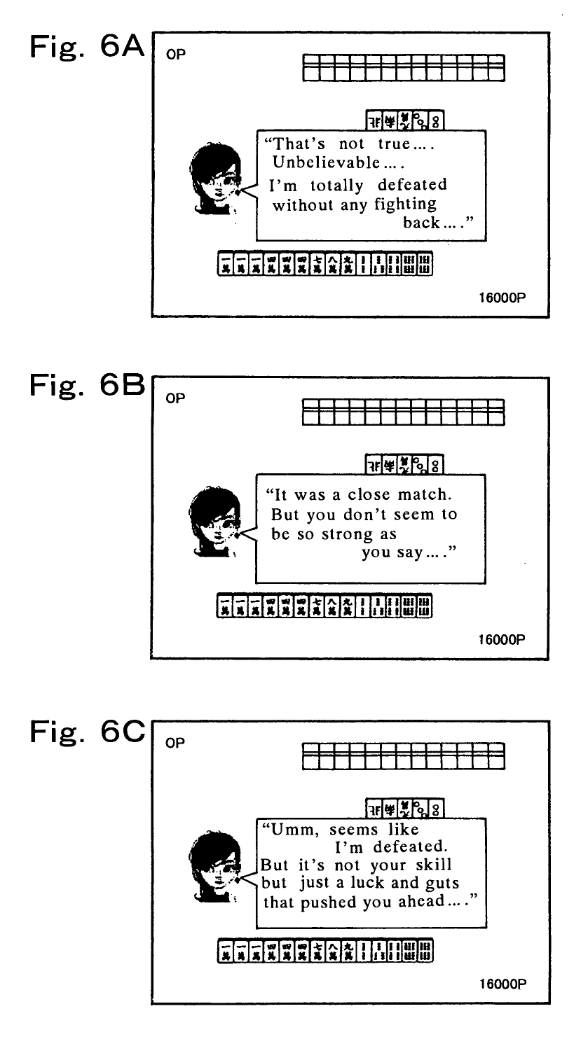

The usual attractions will later be explained in detail with reference to FIG. 6.

After executing the process of step S46, this subroutine is terminated.

During when the subroutine shown in FIG. 5 is executed, the control unit 30 functions as selecting means which selects according to the number of completions by the opponent character in response to the winning over the opponent character, a usual attraction data item from a plurality of usual attraction data items stored in the ROM 32.

Also, during when the subroutine shown in FIG. 5 is executed, the control unit 30 functions as attraction means which presents usual attractions by images and/or sounds according to the usual attraction data selected by the selecting means.

Images displayed on the display device 13 of the mahjong game machine 10 during when the process of step S46 in the subroutine shown in FIG. 5 is executed will now be explained with reference to FIGS. 6A to 6C.

FIGS. 6A to 6C are views schematically showing examples of images displayed on the display device 13 of the mahjong game machine 10.

The screen images shown in FIGS. 6A to 6C are those displayed on the display device 13 during when the process of step S46 in the subroutine shown in FIG. 5 is executed. The screen images of FIGS. 6A to 6C are those in the case where the opponent character is the character A.

Images showing tiles owned by the player and opponent character are displayed on the lower and upper sides of each of the screen images shown in FIGS. 6A to 6C, respectively. The tiles owned by the opponent character are displayed in a mode directed to the backside so that the player cannot see the details. Displayed on the lower side of the images showing the tiles owned by the opponent character are those showing tiles discarded by the opponent character.

Displayed at the center of each screen image are an image showing a figure of the opponent character (character A) and an image (balloon image) showing lines spoken by the opponent character.

The screen image shown in FIG. 6A is one displayed on the display device 13 in the case where the usual attraction data corresponding to the high favorability is selected at step S43 in the subroutine shown in FIG. 5 and then usual attractions are presented at step S46 according to thus selected usual attraction data.

In FIG. 6A, a balloon image showing the speech “That's not true . . . Unbelievable . . . I'm totally defeated without any fighting back . . . ” is displayed, which indicates that the favorability of the opponent character (character A) with respect to the player is high.

During when the screen image shown in FIG. 6A is displayed, the sound amplifier 37 outputs a voice corresponding to the speech according to the usual attraction data set in the RAM 34.

The screen image shown in FIG. 6B is one displayed on the display device 13 in the case where the usual attraction data corresponding to the middle favorability is selected at step S44 in the subroutine shown in FIG. 5 and then usual attractions are presented at step S46 according to thus selected usual attraction data.

In FIG. 6B, a balloon image showing the speech “It was a close match. But you don't seem to be so strong as you say . . . ” is displayed, which indicates that the favorability of the opponent character (character A) with respect to the player is middle.

During when the screen image shown in FIG. 6B is displayed, the sound amplifier 37 outputs a voice corresponding to the speech according to the usual attraction data set in the RAM 34.

The screen image shown in FIG. 6C is one displayed on the display device 13 in the case where the usual attraction data corresponding to the low favorability is selected at step S45 in the subroutine shown in FIG. 5 and then usual attractions are presented at step S46 according to thus selected usual attraction data.

In FIG. 6C, a balloon image showing the speech “Umm, seems like I'm defeated. But it's not your skill but just a luck and guts that pushed you ahead . . . ” is displayed, which indicates that the favorability of the opponent character (character A) with respect to the player is low.

During when the screen image shown in FIG. 6C is displayed, the sound amplifier 37 outputs a voice corresponding to the speech according to the usual attraction data set in the RAM 34.

In the mahjong game machine 10, as explained with reference to FIGS. 5 and 6A to 6C, the favorability is set according to the number of completions by the opponent character when the player wins over the opponent character, and usual attractions are presented according to usual attraction data selected in conformity to thus set favorability. Therefore, the player can be provided with various attractions, and thus can fully enjoy the mahjong game for a long time without being bored therewith.

FIG. 7 is a flowchart showing the second attraction selecting routine executed as being called at step S18, S20, or S22 in the subroutine shown in FIG. 4.

First, the CPU 31 determines whether the player wins over the opponent character or not (step S50). Namely, the CPU 31 refers to the playing result data stored in the RAM 34, and determines whether or not there is information indicating the winning of the player as a result of the match against the opponent character in the above-mentioned process of step S17, S19, or S21.

If it is determined in step S50 that the player does not win over the opponent character (i.e., is defeated by the opponent character), then the CPU 31 terminates the subroutine shown in FIG. 7. Here, the player is defeated, whereby the game is over.

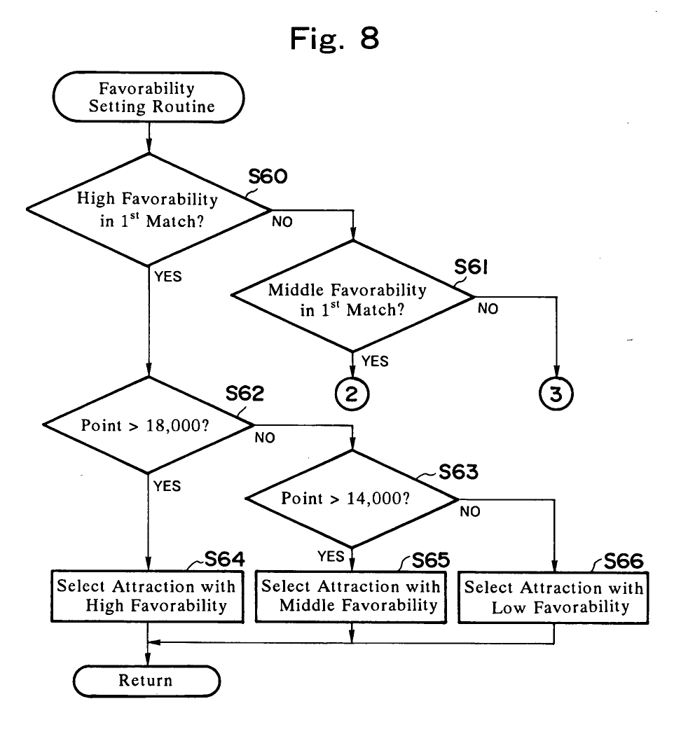

If it is determined in step S50 that the opponent character wins over the opponent character, by contrast, then the CPU 31 executes a favorability setting process (step S51). In the favorability setting process, the favorability is set in 3 (high, middle, and low) stages according to the point of the player after the second match against the character A, B, or C and the favorability of the opponent character in the first match, favorability data concerning thus set favorability is stored into the RAM 34, a usual attraction data item is selected from a plurality of usual attraction data items stored in the ROM 32 according to thus set favorability data, and thus selected usual attraction data item is set into the RAM 34. The usual attraction data set into the RAM 34 in the favorability setting process differs from that concerning the first match set in the RAM 34 in the subroutine shown in FIG. 5. The favorability setting process will later be explained in detail with reference to FIGS. 8 to 10.

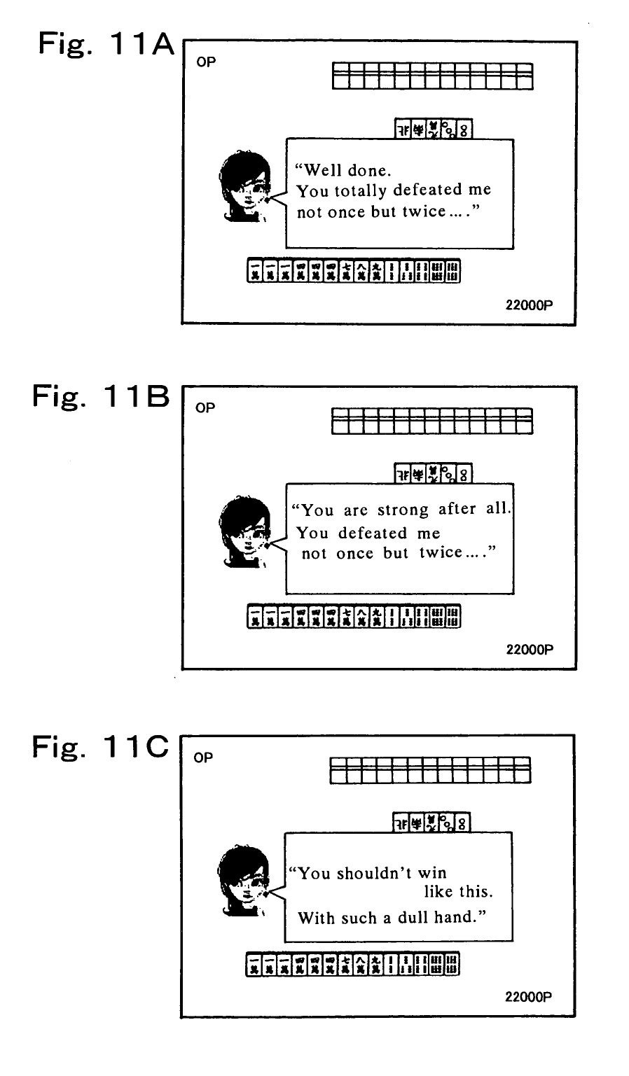

After the process of step S51, the CPU 31 presents the selected attractions (step S52). Namely, the CPU 31 presents usual attractions according to the usual attraction data selected in the above-mentioned process of step S51 and set into the RAM 34. The usual attractions will later be explained in detail with reference to FIG. 11.

After the process of step S52, this subroutine is terminated.

FIGS. 8 to 10 are flowcharts showing the favorability setting routine executed as being called at step S51 in the subroutine shown in FIG. 7. Among FIGS. 8 to 10, a plurality of steps carrying out the same process will be referred to with the same number without repeating their overlapping explanations.

First, as shown in FIG. 8, the CPU 31 determines whether the first match is with the high favorability or not (step S60). Namely, referring to the favorability data concerning the first match stored in the RAM 34, the CPU 31 determines whether the favorability is high or not.

If it is determined in step S60 that the first match is with the high favorability, then the CPU 31 determines whether the point of the player exceeds 18,000 or not (step S62). Namely, referring to the playing result data stored in the RAM 34, the CPU 31 determines whether the point acquired by the player exceeds 18,000 or not.

If it is determined in step S62 that the point of the player exceeds 18,000, then the CPU 31 selects attractions with the high favorability (step S64). Namely, the CPU 31 sets the favorability of the opponent character as high, stores favorability data concerning thus set favorability into the RAM 34, selects a usual attraction data item corresponding to the high favorability from a plurality of usual attraction data items stored in the ROM 32, and sets thus selected usual attraction data item into the RAM 34.

If it is determined at step S62 that the point of the player does not exceed 18,000, by contrast, then the CPU 31 determines whether the point of the player exceeds 14,000 or not (step S63).

If it is determined in step S63 that the point of the player exceeds 14,000, then the CPU 31 selects attractions with the middle favorability (step S65). Namely, the CPU 31 sets the favorability of the opponent character as middle, stores favorability data concerning thus set favorability into the RAM 34, selects a usual attraction data item corresponding to the middle favorability from a plurality of usual attraction data items stored in the ROM 32, and sets thus selected usual attraction data item into the RAM 34.

If it is determined in step S63 that the point of the player does not exceed 14,000, then the CPU 31 selects attractions with the low favorability (step S66). Namely, the CPU 31 sets the favorability of the opponent character as low, stores favorability data concerning thus set favorability into the RAM 34, selects a usual attraction data item corresponding to the low favorability from a plurality of usual attraction data items stored in the ROM 32, and sets thus selected usual attraction data item into the RAM 34.

If it is determined in the above-mentioned step S60 that the favorability in the first match is not high, then the CPU 31 determines whether the favorability of the first match is middle or not (step S61).

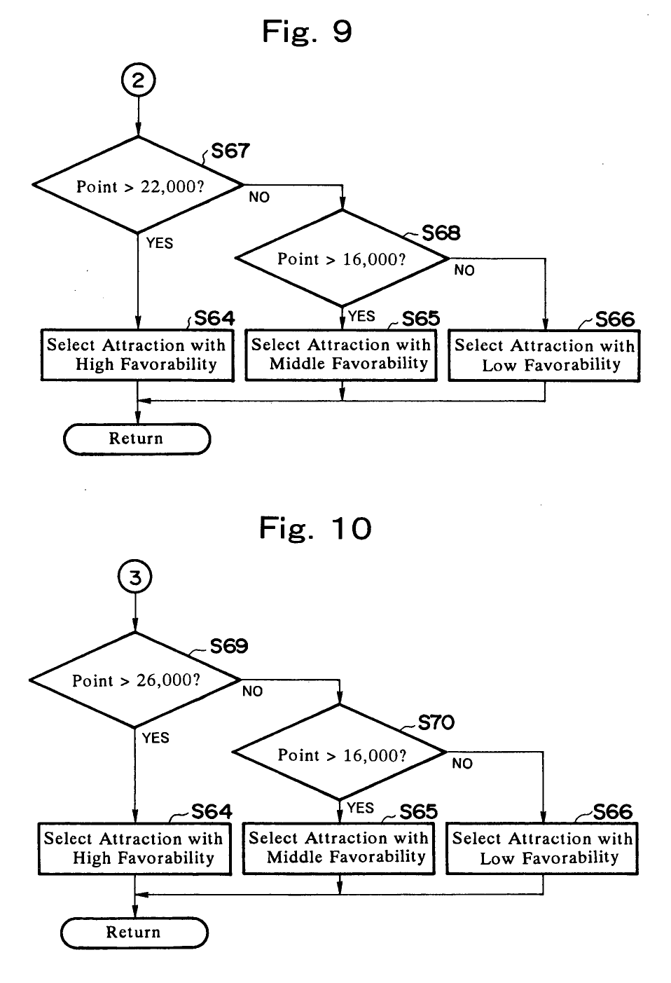

If it is determined in step S61 that the favorability of the first match is middle, the CPU 31 determines whether the point of the player exceeds 22,000 or not (step S67 (see FIG. 9)).

If it is determined in step S67 that the point of the player exceeds 22,000, the CPU 31 selects attractions with the high favorability (step S64).

If it is determined in step S67 that the point of the player does not exceed 22,000, then the CPU 31 determines whether the point of the player exceeds 16,000 or not (step S68).

If it is determined in step S68 that the point of the player exceeds 16,000, the CPU 31 selects attractions with the middle favorability (step S65).

If it is determined in step S68 that the point of the player does not exceed 16,000, the CPU 31 selects attractions with the low favorability (step S66).

If it is determined in the above-mentioned step S61 (see FIG. 8) that the favorability in the first match is not middle (i.e., the favorability is low), then the CPU 31 determines whether the point of the player exceeds 26,000 or not (step S69 (see FIG. 10)).

If it is determined in step S69 that the point of the player exceeds 26,000, the CPU 31 selects attractions with the high favorability (step S64).

If it is determined in step S69 that the point of the player does not exceed 26,000, by contrast, the CPU 31 determines whether the point of the player exceeds 16,000 or not (step S70).

If it is determined in step S70 that the point of the player exceeds 16,000, the CPU 31 selects attractions with the middle favorability (step S65).

If it is determined in step S70 that the point of the player does not exceed 16,000, by contrast, the CPU 31 selects attractions with the low favorability (step S66).

After executing the process of step S64, S65, or S66, this subroutine is terminated.

During when the subroutine shown in FIGS. 8 to 10 is executed, the control unit 30 functions as selecting means which selects, according to the favorability of the opponent character in the first match and the point acquired by the player in response to the winning over the opponent character, a usual attraction data item from a plurality of usual attraction data items stored in the ROM 32. During when the subroutine shown in FIG. 7 is executed, the control unit 30 functions as attraction means which presents usual attractions based on images and/or sounds according to the usual attraction data selected as the attraction data by the selecting means.

Images displayed on the display device 13 of the mahjong game machine 10 during when the process of step S52 in the subroutine shown in FIG. 7 is executed will now be explained with reference to FIGS. 11A to 11C.

FIGS. 11A to 11C are views schematically showing examples of images displayed on the display device 13 of the mahjong game machine 10.

The screen images shown in FIGS. 11A to 11C are images displayed on the display device 13 during when the process of step S52 in the subroutine shown in FIG. 7 is executed. The screen images shown in FIGS. 11A to 11C are those in the case where the opponent character is the character A.

Images showing tiles owned by the player and opponent character are displayed on the lower and upper sides of each of the screen images shown in FIGS. 11A to 11C, respectively. The tiles owned by the opponent character are displayed in a mode directed to the backside so that the player cannot see the details. Displayed on the lower side of the images showing the tiles owned by the opponent character are those showing tiles discarded by the opponent character.

Displayed at the center of each screen image are an image showing a figure of the opponent character (character A) and an image (balloon image) showing words spoken by the opponent character.

The screen image shown in FIG. 11A is one displayed on the display device 13 in the case where the usual attraction data corresponding to the high favorability is selected at step S64 in the subroutine shown in FIGS. 8 to 10 and then usual attractions are presented according to thus selected usual attraction data at step S52 in the subroutine shown in FIG. 7.

In FIG. 11A, a balloon image showing the speech “Well done. You totally defeated me not once but twice . . . ” is displayed, which indicates that the favorability of the opponent character (character A) with respect to the player is high.

During when the screen image shown in FIG. 11A is displayed, the sound amplifier 37 outputs a voice corresponding to the speech according to the usual attraction data set in the RAM 34.

The screen image shown in FIG. 11B is one displayed on the display device 13 in the case where the usual attraction data corresponding to the middle favorability is selected at step S65 in the subroutine shown in FIGS. 8 to 10 and then usual attractions are presented according to thus selected usual attraction data at step S52.

In FIG. 11B, a balloon image showing the speech “You are strong after all. You defeated me not once but twice . . . ” is displayed, which indicates that the favorability of the opponent character (character A) with respect to the player is middle.

During when the screen image shown in FIG. 11B is displayed, the sound amplifier 37 outputs a voice corresponding to the speech according to the usual attraction data set in the RAM 34.

The screen image shown in FIG. 11C is one displayed on the display device 13 in the case where the usual attraction data corresponding to the low favorability is selected at step S66 in the subroutine shown in FIGS. 8 to 10 and then usual attractions are presented according to thus selected usual attraction data at step S52.

In FIG. 11C, a balloon image showing the speech “You shouldn't win like this. With such a dull hand.” is displayed, which indicates that the favorability of the opponent character (character A) with respect to the player is low.

During when the screen image shown in FIG. 11C is displayed, the sound amplifier 37 outputs a voice corresponding to the speech according to the usual attraction data set in the RAM 34.

When the player wins the second match against the opponent character (character A to C) in the mahjong game machine 10 in accordance with this embodiment, as explained with reference to FIGS. 7 to 11C, the favorability is set according to the favorability of the opponent character in the first match and the point acquired by the player, and usual attractions are presented according to the usual attraction data selected in conformity to thus set favorability. Therefore, the player can be provided with various attractions, and thus can fully enjoy the mahjong game for a long time without being bored.

FIG. 12 is a flowchart showing an ending routine executed as being called at step S27 of the subroutine shown in FIG. 4. In FIG. 12, a plurality of steps executing the same process are referred to with the same numeral. The processes in the steps referred to with the same numeral will not be explained in an overlapping manner.

First, the CPU 31 determines whether or not there is any opponent character whose favorability is set to high twice (step S80). Namely, the CPU 31 refers to favorability data of characters A to C against each of which the player has played twice among 5 opponent characters (characters A to E) stored in the RAM 34, and determines whether there is any opponent character whose favorability is set to high in both of the 2 matches.

If it is determined in step S80 that there is an opponent character whose favorability is set to high twice, then the CPU 31 determines whether or not there are at least 2 opponent characters falling under this category (step S81). Namely, the CPU 31 refers to the favorability data concerning characters A to C stored in the RAM 34, and determines whether or not there are at least 2 opponent characters whose favorability is set to high in both of the 2 matches.

If it is determined in step S81 that there are 2 or more opponent characters falling under this category, the CPU 31 presents 2-shot ending attractions with an opponent character against which the player acquired the highest total point in the first and second matches among the opponent characters falling under this category and the player (step S83). In the process of step S83, an ending attraction data item concerning the 2-shot ending with the opponent character and the player is selected from a plurality of ending attraction data items stored in the ROM 32 and is set into the RAM 34, and ending attractions are presented according to thus set ending attraction data item.

If it is determined in step S81 that there is less than 2 opponent characters (only 1 opponent character) falling under this category, the CPU 31 presents 2-shot ending attractions with this opponent character and the player (step S82).

If it is determined in the above-mentioned step S80 that there is no opponent character whose favorability is set to high twice, then the CPU 31 determines whether or not there is any opponent character whose favorability is set to high once (step S84).

If it is determined in step S84 that there is a character whose favorability is set to high once, then the CPU 31 determines whether or not there are at least 2 opponent characters falling under this category (step S85).

If it is determined in step S85 that there are 2 or more opponent characters falling under this category, the CPU 31 presents 2-shot ending attractions with an opponent character against which the player acquired the highest total point in the first and second matches among the opponent characters falling under this category and the player (step S83).

If it is determined in step S85 that there is less than 2 opponent characters (only 1 opponent character) falling under this category, the CPU 31 presents 2-shot ending attractions with this opponent character and the player (step S82).

If it is determined in the above-mentioned step S84 that there is no opponent character whose favorability is set to high once (the favorability is middle or low in all the matches), ending attractions with all the opponent characters and the player are presented (step S88). In the process of step S88, an ending attraction data item concerning the ending attractions with all the characters is selected from a plurality of ending attraction data items stored in the ROM 32 and is set into the RAM 34, and ensemble ending attractions are presented according to thus set ending attraction data item.

After executing the process of step S82, S83, or S88, this subroutine is terminated.

During when the subroutine shown in FIG. 12 is executed, the control unit 30 functions as selecting means which selects, according to favorabilities of 5 opponent characters (characters A to E) in response to the winning over all the matches against the 5 opponent characters, an ending attraction data item as attraction data from a plurality of ending attraction data items stored in the ROM 32.

Also, when the subroutine shown in FIG. 12 is executed, the control unit 30 functions as attraction means which presents ending attractions based on images and sounds according to the ending attraction data selected by the selecting means.

The mahjong game machine may comprise a printer so as to print out the attraction images shown in FIG. 12.

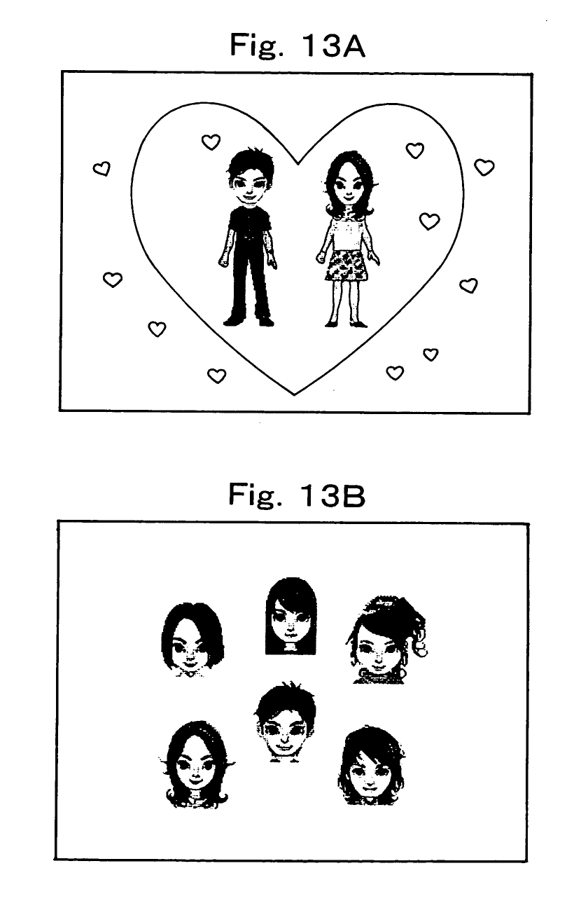

Images displayed on the display device 13 of the mahjong game machine 10 during when the processes of step S82, S83, and S88 of the subroutine shown in FIG. 12 are executed will now be explained with reference to FIGS. 13A and 13B.

FIGS. 13A and 13B are views schematically showing examples of images displayed on the display device 13 of the mahjong game machine 10.

The screen image shown in FIG. 13A is an image illustrating a 2-shot picture of the player and opponent character displayed on the display device 13 during when the process of step S82 or S83 shown in FIG. 12 is executed. The screen image displayed in FIG. 13A is an image in the case where the opponent character is the character B.

Displayed on the left and right sides of the screen image shown in FIG. 13A are images indicating a male player and a female opponent character (character B), respectively, whereas an image simulating a heart surrounds the player and opponent character. During when the images shown in FIG. 13A are displayed, the sound amplifier 37 outputs sounds such as BGM (background music) according to the ending attraction data set in the RAM 34.

The screen image shown in FIG. 13B is an image illustrating a group picture of the player and all the opponent characters displayed on the display device 13 during when the process of step S88 shown in FIG. 12 is executed.

An image indicating the face of the player is displayed at substantially the center of the screen image shown in FIG. 13B, whereas respective images showing the faces of 5 opponent characters surround the player. During when the images shown in FIG. 13B are displayed, the sound amplifier 37 outputs sounds such as BGM (background music) according to the ending attraction data set in the RAM 34.

The mahjong game machine 10 in accordance with this embodiment, as explained in detail with reference to FIGS. 12 to 13B, ending attraction data is selected as attraction data according to the favorabilities of 5 opponent characters (characters A to E) when the player wins all the matches against the 5 opponent characters, and ending attractions are presented according to thus selected attraction data. Therefore, the player can be provided with various attractions, and thus can fully enjoy the mahjong game for a long time without being bored.

Also, in order to see a 2-shot ending with a favorite opponent character among the characters A to E, the player can strategically play the mahjong game such that, for example, the opponent characters other than the favorite character are intentionally allowed to complete a hand so as to lower their favorabilities. Thus, a mahjong game to which conventionally unavailable fun is added can be provided.

Though the above-mentioned mahjong game machine relates to a case where attraction data are selected according to the number of completions by opponent characters, the point acquired by the player, and the favorability, attraction data are not limited to those mentioned above as long as they are selected according to playing results. For example, attraction data may be selected according to the kind and rank of the hand completed by the player, the successive number of completions by the player, the number of completions by the opponent characters upon feeding from the player, and the like.

Though the above-mentioned mahjong game machine relates to a case where the player wins when the point of the opponent character becomes zero or when the player completes a hand 3 times, the condition under which the player wins against the opponent character is not limited in particular, examples of which include a completion with a specific hand and a predetermined number of completions in series in addition to those mentioned above.

The first embodiment of the present invention can provide a mahjong game machine which is configured such that, according to a playing result against an opponent character in response to the wining over the opponent character, an attraction data item is selected from a plurality of attraction data items, and attractions based on images and/or sounds are presented according to thus selected attraction data. This can provide a mahjong game machine which can supply various attractions in conformity to details of playing, so that the player can fully enjoy the mahjong game for a long time without being bored.

Also, the first embodiment can provide a mahjong game machine which is configured such that attraction data includes a plurality of ending attraction data items concerning ending attractions presented in response to the winning over all of a plurality of opponent characters, whereby a mahjong game can be played strategically.

Further, the first embodiment can provide a mahjong game machine control program which is configured such that, according to a playing result against an opponent character in response to the winning over the opponent character, an attraction data item is selected from a plurality of attraction data items, and attractions based on images and/or sounds are presented according to thus selected attraction data item. This mahjong game machine control program can supply various attractions, so that the player can fully enjoy the mahjong game for a long time without being bored.

Furthermore, the first embodiment can provide a mahjong game machine control program which is configured such that attraction data includes a plurality of ending attraction data items concerning ending attractions presented in response to the winning over all of a plurality of opponent characters, whereby a mahjong game can be played strategically.

### Second Embodiment

In the following, a second embodiment of the present invention will be explained with reference to the drawings. The part of the second embodiment overlapping the first embodiment will not be explained. An example of mahjong game machine in accordance with the second embodiment is represented by FIG. 1 as in the first embodiment.

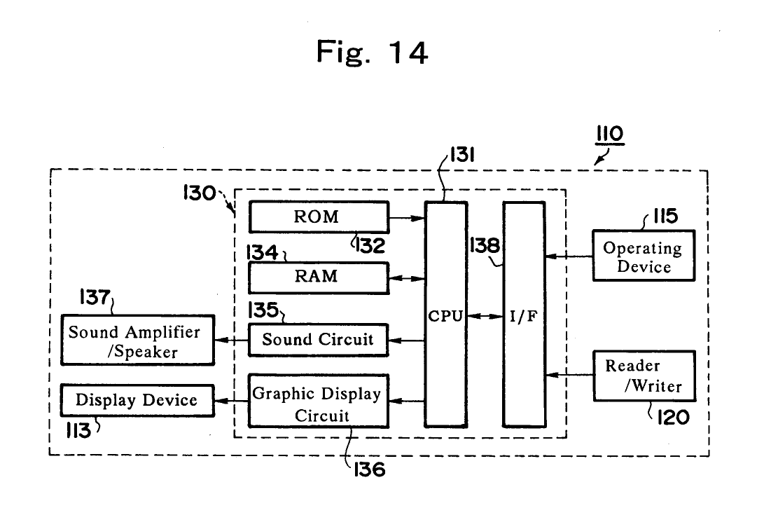

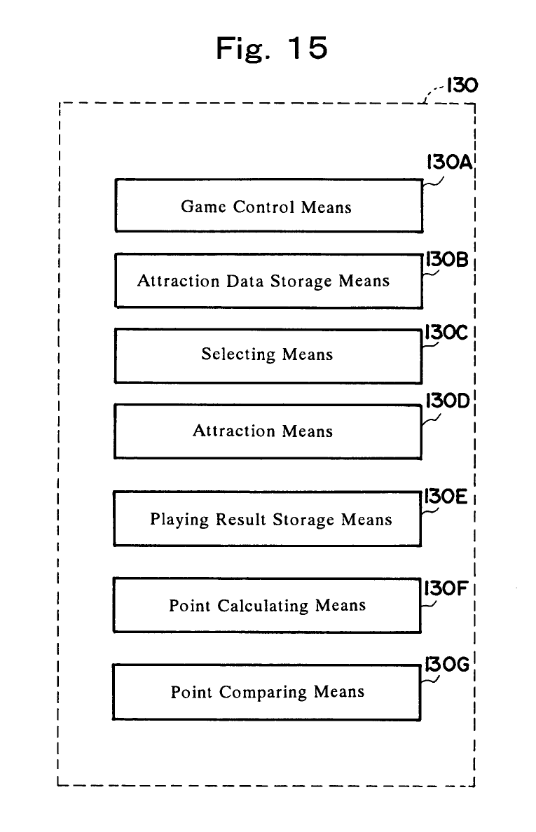

Though not shown in FIG. 1, a memory card reader/writer 120 is provided in order for image data of ending attractions obtained as a result of playing against an opponent character to be stored into an external storage medium such as memory card (see FIG. 14).

The operating board 14 of the mahjong game machine 10 (110) is represented by FIG. 2 as in the first embodiment.

FIG. 14 is a block diagram schematically showing the inner configuration of the mahjong game machine 110. As shown in FIG. 14, a control unit 130 is disposed within a housing 11 of the mahjong game machine 110. The control unit 130 includes a CPU (Central Processing Unit) 131, a ROM (Read-Only Memory) 132, and a RAM (Random Access Memory) 134.

FIG. 15 is a functional block diagram of the controller 130. As can be seen from this diagram, the control unit 130 functions as:

game control means 130A which executes a game program concerning a mahjong game according to a control signal from an operating device 115 manipulated by the player and calculates a result of winning/losing in the mahjong game;

attraction data storage means 130B which stores a plurality of attraction data items associated with results of winning/losing calculated by the game control means 130A;

selecting means 130C which selects, according to the result of winning/losing calculated by the game control means 130A, an attraction data item from the plurality of attraction data items stored in the attraction data storage means 130B;

attraction means 130D which causes a display device 113 to present attractions by images according to the attraction data item selected by the selecting means 130C;

playing result storage means 130E which cumulatively stores playing results as the results of winning/losing calculated by the game control means 130A;

point calculating means 130F which carries out a subtraction or addition of the point of the player or an opponent characters according to the result of winning/losing; and

point comparing means 130G which compares the point of the player or each opponent character with a reference in order to select a character to appear in an ending attraction image.

The CPU 131 is connected to the operating device 115 by way of an interface circuit (I/F) 138. The CPU 131 carries out various processes according to control signals from the operating device 115, so as to proceed with the mahjong game.

The ROM 132 stores various kinds of image data such as image data of tiles and opponent characters displayed on the display device 113, and a mahjong game machine control program for regulating the total flow of the mahjong game. The ROM 132 also stores a plurality of items of usual attraction data as attraction data for each opponent character. The usual attraction data include image data, sound data, and the like for presenting usual attractions to be presented in response to the winning over the opponent characters. The ROM 132 stores a plurality of items of ending attraction data as attraction data. The ending attraction data include image data, sound data, and the like for presenting ending attractions to be presented in response to the winning over all the plurality of opponent characters.

The sound data are not restricted in particular, and may be data of voices such as talks, cries, and exclamations of people, and music, which may be used in combination. The image of each opponent character may represent the whole body or a part thereof such as a face. The attractions may be carried out with one or both of image and sound.

In the following, data may also be referred to as voice data, since the present invention mainly uses voice data such as speeches of people.

The ROM 132 functions as attraction data storage means which stores attraction data such as usual attraction data concerning usual attractions and ending attraction data concerning ending attractions.

The RAM 134 also stores playing result data. The playing result data include information concerning winning/losing in matches against the opponent characters, points acquired by the player in matches against the opponent characters, the number of completions by the opponent characters, and the like. Namely, the RAM 134 functions as the playing result storage means 130E shown in FIG. 15. The playing result storage means 130E cumulatively stores the playing result data until the game is over.

A sound circuit 135 is connected to a sound amplifier 137 which outputs various voices corresponding to states of proceeding with the mahjong game. A graphic display circuit 136 causes the display device 113 to display an image selected according to a control signal from the CPU 131.

An example of mahjong game played with the mahjong game machine 110 will now be explained in detail.

(A) Game Rule

The player successively plays mahjong against 5 opponent characters (characters A to E). When the player wins over all the 5 opponent characters, the game ends, whereby ending attractions which will be explained later is provided. If a favorability which will be explained later falls within a predetermined condition at the time when the matches against the characters A to C end, a second match with the characters A to C is carried out. In this case, 2 matches are played for each of the characters A to C, and then a match with each of the characters D and E, thus yielding 8 matches in total.

Each of the player and opponent characters owns a predetermined point (e.g., 10,000) at the time of starting matches. If the point of an opponent character becomes zero or the player completes a hand 3 times, the player wins. If the point of the player becomes zero because the opponent character completes a hand and so forth, by contrast, the game will be over.

(B) Favorability and Usual Attractions

When the player wins over an opponent character, the favorability of the opponent character with respect to the player is set in 3 (high, middle, and low) stages according to the result of playing, and usual attractions are presented according to thus set favorability. In the usual attractions, states in which the opponent character speaks various lines are displayed on the display device 113 according to the favorability of the opponent character.

(C) Ending Attractions

When the player wins over all the 5 opponent characters, ending attractions corresponding to the results of matches against the 5 opponent characters are presented. In the ending attractions, according to the favorability set for each of the 5 opponent characters, an image showing a 2-shot picture with one of the 5 opponent characters or a group picture of all the 5 characters and the player is displayed on the display device 113.

For displaying the above-mentioned attractions of (B) and (C), the ROM 132 functions as the attraction data storage means 130B, and attraction data concerning the favorability or ending corresponding to the playing result are extracted from the attraction data storage means 130B.

The subroutines shown in FIGS. 4, 5, and 7 to 12 used for explaining the first embodiment are also executed in the mahjong game machine 110, and thus will not be explained in detail here.

During when the subroutine shown in FIG. 5 is executed, the control unit 130 functions as the attraction means 130D which presents usual attractions by images and/or sounds according to usual attraction data selected by the selecting means 130C. During when the subroutines shown in FIGS. 4 and 5 are executed, the RAM 134 functions as the playing result storage means 130E which stores playing result data.

The images shown in FIGS. 6A to 6C, 11A to 11C, and 13A and 13B explained in the first embodiment are also displayed on the display device 113 of the mahjong game machine 110, and thus will not be explained here.

The second embodiment can be modified as with the first embodiment, though not explained here.

If it is determined in step S62 shown in FIG. 8 that the point of the player does not exceed 18,000, then the CPU 131 determines whether the point of the player exceeds 14,000 or not (step S63) as mentioned above. Such a calculating process is carried out by the point calculating means 130F, whereas a comparing process is carried out by the point comparing means 130G.

The second embodiment selects an attraction data item from a plurality of attraction data items according to results of winning/losing of the mahjong game, and thus can provide the player with various attractions unlike conventional uniform attractions.

The second embodiment can cumulatively store a plurality of playing results against a plurality of opponent characters into playing result storage means, and display various attraction data according to thus cumulatively stored playing results such that, for example, the display device displays attraction data including an image of an opponent character feeding the largest number of tiles to the player, and displays attraction data including images of all the opponent characters if the player completes a hand in all the cumulatively stored playing results. This can make attractions themselves rich with variations, and additionally provide new fun by allowing the player to play games strategically so as to attain attraction data to display. For example, friends may compete against each other in terms of which ending images they have seen as ending attractions. Attraction data selected by the selecting means may be stored into external storage means attachable to and detachable from the mahjong game machine, or transferred via communication networks such as the Internet to addresses of cellular phones, PCs, etc. designated by the player. Thus, friends can play a new game of showing their collected ending images to each other.

In the case where ending attractions are presented from when the point of the cumulatively stored playing result becomes minus, it can be easier for the player to see at which point the ending attractions are presented. For example, the mahjong game machine may be provided with a money collector such as a coin selector such that money can be added during games. The point calculating means may be configured so as to increase the point of the player when money such as a coin is inserted into the money collector, thus promoting a possibility of getting rarer ending attractions and better playing results, thereby enhancing the money collecting ability of the mahjong game machine.

The mahjong game machine control program in accordance with this embodiment may be sold as being stored in an external storage medium such as memory card, CD-ROM, and ROM cartridge. Also, such a mahjong game control program may be stored in a memory such as hard disk in a server so as to be downloadable to a plurality of terminals connected to a wide area network such as the Internet or a local network connected to a specific terminal on condition that terminal operations are charged. When a computer executes thus provided mahjong game machine control program, the mahjong game can be played.

### Third Embodiment

A third embodiment of the present invention will now be explained in detail with reference to the drawings. The part of the third embodiment overlapping the first invention will not be explained.

In this embodiment, an arcade mahjong game placed in a so-called arcade, with which a player plays a game by inserting a fee, will be explained as the game machine with reference to the drawings.

An example of mahjong game machine in accordance with this embodiment is illustrated by FIG. 1 as in the first embodiment.

The operating board 14 of the mahjong game machine 10 (210) is represented by FIG. 2 as in the first embodiment.

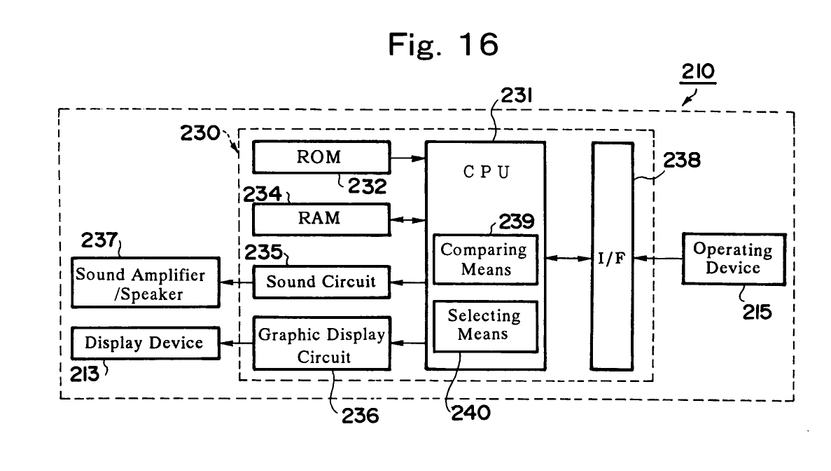

FIG. 16 is a block diagram schematically showing the inner configuration of the mahjong game machine 210. As shown in FIG. 16, a control unit 230 is disposed within a housing 11 of the mahjong game machine 210. The control unit 230 comprises a CPU (central processing unit) 231, a ROM (Read-Only Memory) 232 as storage means, and a RAM (Random Access Memory) 234 as temporary storage means.

The CPU 231 is connected to an operating device 215 by way of an interface circuit (I/F) 238. By carrying out various processes according to control signals from the operating device 215, the CPU 231 proceeds with the mahjong game.

The ROM 232 stores various kinds of image data such as image data of tiles and opponent characters displayed on the display device 213, and a mahjong game machine control program for regulating the total flow of the mahjong game. The ROM 232 also stores results of playing against opponent characters classified into a plurality of evaluation levels beforehand. Details will be explained later. The ROM 232 further stores a plurality of items of usual attraction data as attraction data for each opponent character. The usual attraction data include image data, sound data, and the like for presenting usual attractions to be presented in response to the winning over the opponent characters. The ROM 232 stores a plurality of items of ending attraction data as attraction data. The ending attraction data include image data, sound data, and the like for presenting ending attractions to be presented in response to the winning over all the plurality of opponent characters.

The sound data are not restricted in particular, and may be data of voices such as talks, cries, and exclamations of people, and music, which may be used in combination. The image of each opponent character may represent the whole body or a part thereof such as a face. The attractions may be carried out with one or both of image and sound.

In the following, data may also be referred to as voice data, since the present invention mainly uses voice data such as speeches of people.

The ROM 232 functions as attraction data storage means which stores attraction data such as usual attraction data concerning usual attractions and ending attraction data concerning ending attractions.

The RAM 234 stores playing result data. The playing result data include information concerning winning/losing in matches against the opponent characters, points acquired by the player in matches against the opponent characters, the number of games finished by the opponent characters, and the like.

A sound circuit 235 is connected to a sound amplifier 237 which outputs various voices corresponding to states of proceeding with the mahjong game. A graphic display circuit 236 functions as display control means which successively displays on the display device 213 the opponent characters replaced according to the evaluation level based on the results of playing, and causes the display device 213 to display images selected by control signals from the CPU 231.

The CPU 231 functions as comparing means 239 which compares playing result data stored in the RAM 234 with an evaluation level stored in the ROM 232, and as selecting means 240 which selects from a plurality of kinds of image data an opponent character to be displayed as a replacement on the display device 213 according to a result of comparison by the comparing means 239.

Further, the ROM 232 stores a game machine control program which causes the CPU 231 to function as comparing means 239 which compares the playing result data stored in the RAM 234 with the evaluation level, and as selecting means 240 which selects from a plurality of kinds of image data an opponent character to be displayed as a replacement on the display device 213 according to a result of comparison by the comparing means 239.

Though a plurality of evaluation levels based on playing results are classified with reference to a favorability condition such as information concerning the winning/losing in matches against opponent characters, the point information acquired by the player in matches against opponent characters, the number of completions by opponent characters, and the like in this embodiment, they are not restrictive. The determination can be based on whether or not a hand which can acquire a high point is completed, whether or not a specific hand is completed, whether or not a discarded tile achieving a so-called goal state is fed to an opponent character, whether or not a cheap hand is completed, etc.

An example of mahjong game played with the mahjong game machine 210 will now be explained in detail.

(A) Game Rule

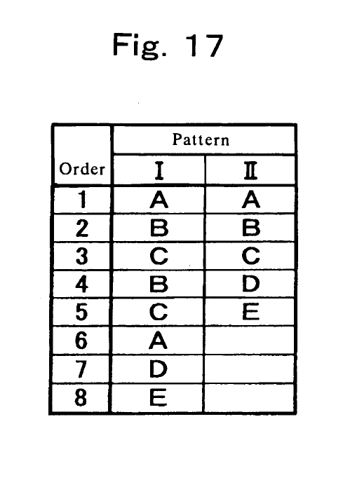

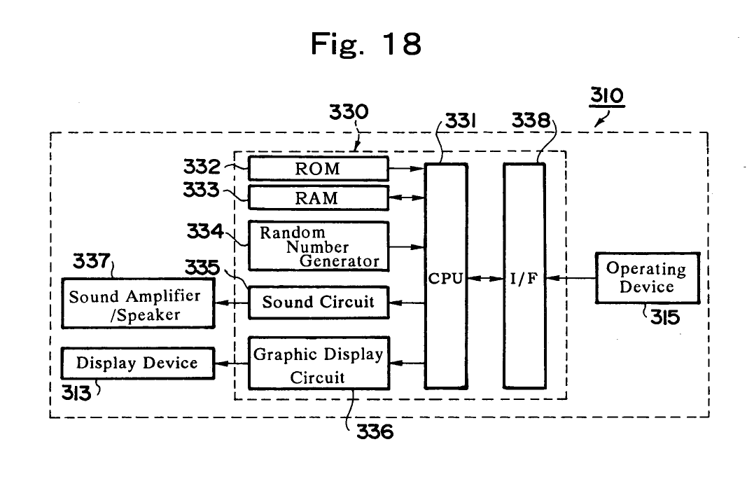

The player successively plays mahjong against 5 opponent characters (characters A to E). When the player wins over all the 5 opponent characters, the game ends, whereby ending attractions which will be explained later is provided. If a favorability, which will be explained later, as a result of comparison by the function of the comparing means 239 by the CPU 231 between the playing result temporarily stored in the RAM 234 and the evaluation level stored in the ROM 232 falls within a predetermined condition at the time when the matches against the characters A to C are completed, the opponent characters A to C are selected from a plurality of opponent characters to be displayed as a replacement on the display device 213 by the function of the selecting means 240 by the CPU 231 and a second match with the characters A to C is carried out. In this case, 2 matches are played for each of the characters A to C, and then a match with each of the characters D and E, thus yielding 8 matches in total. FIG. 17 shows two matching order patterns with opponent characters (characters A to E) stored in the ROM 232 beforehand. The function of the selecting means 240 by the CPU 231 selects one of patterns I and II according to data of playing results against the opponent characters so far.

Each of the player and opponent characters owns a predetermined point (e.g., 10,000) at the time of starting matches. If the point of an opponent character becomes zero or the player completes a hand 3 times, the player wins. If the point of the player becomes zero because the opponent character completes a hand and so forth, by contrast, the game will be over.

(B) Favorability and Usual Attractions

When the player wins over an opponent character, the favorability of the opponent character with respect to the player is set in 3 (high, middle, and low) stages according to the playing result by comparison with a plurality of evaluation levels classified according to playing results against opponent characters stored in the ROM 232 beforehand, and usual attractions are presented according to thus set favorability. In the usual attractions, states in which the opponent character speaks various lines are displayed on the display device 213 according to the favorability of the opponent character.

(C) Ending Attractions

When the player wins over all the 5 opponent characters, ending attractions corresponding to the results of matches against the 5 opponent characters are presented. In the ending attractions, according to the favorability set for each of the 5 opponent characters, an image showing a 2-shot picture with one of the 5 opponent characters or a group picture of all the 5 characters and the player is displayed on the display device 213.

The subroutines shown in FIGS. 4, 5, and 7 to 12 used for explaining the first embodiment are also executed in the mahjong game machine 210, and thus will not be explained in detail here.

After the process of step S15 in FIG. 4, the CPU 231 causes the comparing means 239 to determine whether the number of low favorabilities temporarily stored in the RAM 234 as playing result data as a result of matches against 3 opponent characters A to C so far is less than 2 or not (step S16). Namely, referring to favorability data concerning characters A to C stored in the RAM 234, the CPU 231 determines, as a function of the comparing means 239, whether or not the number of opponent characters set to the low favorability as a classification of evaluation level stored beforehand in the ROM 232 is less than 2.

If the CPU 231 determines, as a function of the comparing means 239, in step S16 that the number of favorabilities set as low is less than 2, the CPU 231 executes a process concerning a match against the character B (step S17). The process in step S17 causes the player to play a second match against the character B.

If the CPU 231 determines, as a function of the comparing means 239, in step S16 of FIG. 4 that the number of low favorabilities stored in the ROM 232 is at least 1 and thus satisfies an evaluation level classifying condition, and that the number is not less than 2 (i.e., is at least 2), the CPU 231 as a function of the selecting means 240 selects the character E and executes a process concerning a match against the character E (step S28), the first attraction selecting process (step S29), a process concerning a match against the character D (step S30), and then the first attraction selecting process (step S31).

As mentioned above, the function of the comparing means 239 in the CPU 231 compares the player's playing result against opponent characters with a plurality of evaluation levels stored beforehand in the ROM 232, and an evaluation level for the player's playing result is determined according to the results of comparison by the comparing means 239. Then, according to the evaluation level determined by the function of the selecting means 240 in the CPU 231, the opponent character to be displayed as a replacement on the display device 213 is selected. Thus, instead of a uniform game flow in which opponent characters are displayed in a predetermined order so as to be played against, opponent characters are replaced and selectively displayed according to the player's playing results so as to be played against in this embodiment. For example, taking account of the next opponent character to play against, the player can play strategically with various ways, so as to win by a wide or narrow margin in order to proceed with a confrontation game advantageously. Hence, a quite amusing game can be provided, and the player is less likely to be bored soon even when playing a plurality of confrontation games in series and can enjoy playing the confrontation games continuously.

If it is determined in step S41 shown in FIG. 5 that the opponent character completes a hand, then the CPU 231 determines whether the number of completions by the opponent character is less than 3 or not as mentioned above (step S42). Namely, referring to the playing result data stored in the RAM 234, the CPU 231 as the function of the comparing means 239 determines whether or not the number of completions by the opponent character is less than 3 without satisfying the condition stored beforehand in the ROM 232 that the number is at least 2.

If it is determined as the function of the comparing means 239 in step S42 that the number of completions by the opponent character is less than 3, then the CPU 231 selects attractions with the middle favorability (step S44). Namely, the CPU 231 sets the favorability of the opponent character as middle, stores the favorability data concerning thus set favorability into the RAM 234, selects a usual attraction data item corresponding to the middle favorability from a plurality of usual attraction data items stored in the ROM 232, and sets thus selected data item into the RAM 234.

The images shown in FIGS. 6A to 6C, 11A to 11C, and 13A and 13B explained in the first embodiment are also displayed on the display device 213 of the mahjong game machine 210, and thus will not be explained here.

In this embodiment, if it is determined in step S16 that the number of low favorabilities stored in the RAM 234 is less than 2 after playing against the characters A to C as a consequence of the comparison between the number of low favorabilities stored in the RAM 234 as a result of playing against the characters A to C and the reference for classifying the evaluation level in which the number of low favorability stored beforehand in the ROM 232 is 1, the selecting means 240 selects the characters A to C for the second match. If it is determined that the number of low favorabilities is not less than 2, by contrast, the selecting means 240 selects the characters E, D as new opponent characters to play against. When the selecting means selects the types of the next opponent character to play against as a result of comparison between the playing result data and a predetermined condition stored in the storage means each time a match against a character ends, an amusing game necessitating a strategic play taking account of the types of the next opponent character for each match against an opponent character can be provided. When the selecting means is set so as to successively select opponent characters in an order of increasing difficulty in playing if a better playing result satisfying a predetermined condition is obtained as a result of comparison between the playing result data against each character and the predetermined condition stored in the storage means, a game in which the player must concentrate on each confrontation game against an opponent character in order to win against many opponent characters and thus is hard to be bored can be provided.

Though the confrontation game is exemplified by the mahjong game in the foregoing, this embodiment is applicable to various games to play against characters such as chess and go.

The third embodiment can provide a quite amusing game allowing a strategic playing manner in which the way of playing is changed while taking account of a next opponent character to play against, while the player is less likely to be bored soon even when playing a plurality of confrontation games in series and can enjoy playing the confrontation games continuously.

When the game machine comprises an attachment detachably attaching thereto the storage means for allowing an electric connection, the storage means can detachably be attached to the attachment so as to allow an electric connection. This game machine can change the kinds of games played thereby by a quite easy and simple operation of attaching/detaching storage means storing different kinds of game programs to/from the attachment, and allow various kinds of games to play at a very low cost.

Through a game machine, this embodiment can provide confrontation games against opponent characters selectively displayed by a function as the selecting means according to the player's playing results.

The game machine control program in accordance with this embodiment can be stored into CD-ROMs and ROMs in game cassettes which can be detachably attached to and electrically connected to home game machines and PCs, as well as ROMs used in arcade game machines and CD-ROMs and game cassettes which can be detachably attached to and electrically connected thereto. Also, the game machine control program can be used as a program downloadable from a server machine to the home game machines, PCs, and arcade game machines via communication lines.

### Fourth Embodiment

In the following, a fourth embodiment of the present invention will be explained with reference to the drawings. The part of the fourth embodiment overlapping the first embodiment will not be explained.

An example of mahjong game machine in accordance with this embodiment is illustrated by FIG. 1 as in the first embodiment.

The operating board 14 of the mahjong game machine 10 (310) is represented by FIG. 2 as in the first embodiment.

FIG. 18 is a block diagram schematically showing the inner configuration of the mahjong game machine 310.

As shown in FIG. 18, a control unit 330 is disposed within a housing 11 of the mahjong game machine 310. The control unit 330 comprises a CPU (central processing unit) 331, a ROM (Read-Only Memory) 332, a RAM (Random Access Memory) 333, a random number generator 334, etc.

The CPU 331 is connected to an operating device 315 by way of an interface circuit (I/F) 338. By carrying out various processes according to control signals from the operating device 315, the CPU 331 proceeds with the mahjong game.

The ROM 332 stores various kinds of image data such as image data of tiles and opponent characters (a plurality of opponent characters with respective garments different from each other) displayed on a display device 313, and a mahjong game machine control program for regulating the total flow of the mahjong game. The ROM 332 also stores data such as initial values of variables used in the control program, an opponent character sampling table indicating the correlation between random values and opponent characters used for determining an order of playing against opponent characters, and a character playing order sampling table. The ROM 332 further stores a plurality of items of usual attraction data as attraction data for each opponent character. The usual attraction data include image data, sound data, and the like for presenting usual attractions to be presented in response to the winning over the opponent characters. The ROM 332 also stores a plurality of items of ending attraction data as attraction data. The ending attraction data include image data, sound data, and the like for presenting ending attractions to be presented in response to the winning over all the plurality of opponent characters.

The sound data are not restricted in particular, and may be data of voices such as talks, cries, and exclamations of people, and music, which may be used in combination. The image of each opponent character may represent the whole body or a part thereof such as a face. The attractions may be carried out with one or both of image and sound. In the following, data may also be referred to as voice data, since the present invention mainly uses voice data such as speeches of people.

The ROM 332 functions as attraction data storage means which stores attraction data including usual attraction data concerning usual attraction data and ending attraction data concerning ending attractions.

The RAM 333 is used as a working area for the CPU 331. For example, it stores variables such as playing result data. The playing result data include information concerning winning/losing in matches against the opponent characters, points acquired by the player in matches against the opponent characters, the number of completions by the opponent characters, and the like.

When an opponent character is determined for each match, the RAM 333 stores information of opponent characters remaining unplayed (opponent characters to be sampled).

A sound circuit 335 is connected to a sound amplifier 337 which outputs various voices corresponding to states of proceeding with the mahjong game. A graphic display circuit 336 causes the display device 313 to display an image selected according to a control signal from the CPU 331.

An example of mahjong game played with the mahjong game machine 310 will now be explained in detail.

(A) Game Rule

The player successively plays 5 mahjong matches against 5 opponent characters (characters A to E). When the player wins over all the 5 opponent characters, the game ends, whereby ending attractions which will be explained later is provided. The order of playing against the characters A to E in the mahjong matches is randomly determined by sampling by the opponent character sampling means. For each of the characters A to E, a plurality of figures with respective garments (e.g., uniforms and swimsuits) are prepared, and it is determined with which garment the character appears after determining the character to play against in each match.

Each of the player and opponent characters owns a predetermined point (e.g., 10,000) at the time of starting matches. If the point of an opponent character becomes zero or the player completes a hand 3 times, the player wins. If the point of the player becomes zero because the opponent character completes a hand and so forth, by contrast, the game will be over.

(B) Favorability and Usual Attractions

When the player wins over an opponent character, the favorability of the opponent character with respect to the player is set in 3 (high, middle, and low) stages according to the result of playing, and usual attractions are presented according to thus set favorability. In the usual attractions, states in which the opponent character speaks various lines are displayed on the display device 313 according to the favorability of the opponent character.

(C) Ending Attractions

When the player wins over all the 5 opponent characters, ending attractions corresponding to the results of matches against the 5 opponent characters are presented. In the ending attractions, according to the favorability set for each of the 5 opponent characters, an image showing a 2-shot picture with one of the 5 opponent characters or a group picture of all the 5 characters and the player is displayed on the display device 313.

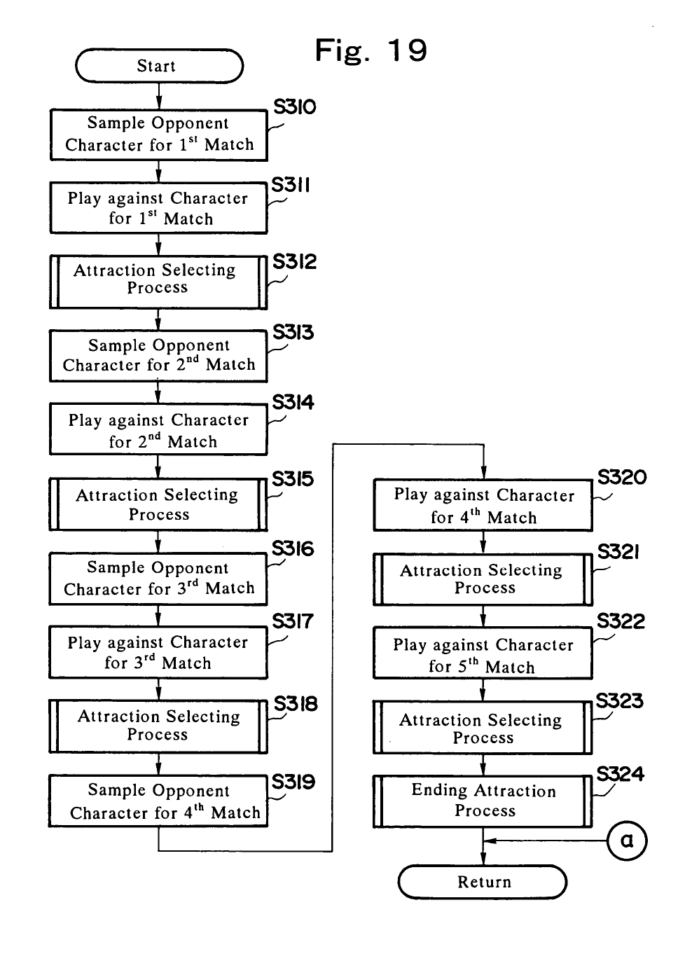

FIG. 19 is a flowchart showing an example of subroutine executed in the mahjong game machine 310. This subroutine determines an opponent character each time a match is started. This subroutine is executed as being called from the mahjong game machine control program for controlling the mahjong game in the mahjong game machine 310 executed beforehand when the player inserts a predetermined coin into the coin insertion slot 18 (see FIG. 1) and pushes the operating button 17f (see FIG. 2) of the operating device 315.

First, the CPU 331 determines the character to play against in the first match from among the characters A to E by sampling (step S310). Specifically, using the random number generator 334, a random number is extracted from within the range of 0 to 4. One character corresponding to this random number is selected from the playing character sampling table in which the characters A to E are associated with the random numbers of 0 to 4, respectively. Subsequently, for determining a garment of thus selected character, a figure with any of a plurality of kinds of garments (e.g., swimsuits, uniforms, Chinese dresses, etc.) is selected by sampling similarly using a random number and a sampling table, whereby the character to play against in the first match is determined. In the process of step S310, for identifying unplayed opponent characters, the CPU 331 initially stores the 5 characters A to E into the RAM 333 in association with their corresponding address information items. After determining the opponent character in the first match, the CPU 331 erases the address information item corresponding to the character used in the first match, and then stores the respective address information items related to the unplayed characters into the RAM 333 in association with the random numbers of 0 to 3, thereby managing the 4 remaining opponent characters.

Though the character to be displayed on the display device 313 in the first match is determined by sampling a garment after determining an opponent character in step S310, an opponent may be determined and displayed by sampling from among a plurality of character images with different impressions due to variations and additions of hairstyles, hair colors, hats, accessories, and the like even in the same character after determining the opponent character.

During when step S310 is executed, the control unit 330 functions as opponent character sampling means which determines an opponent, and character garment sampling means.

After the process of step S310, the CPU 331 executes a process concerning a match against the character determined by sampling in step S310 (step S311). When the process of step S310 is executed, the mahjong game proceeds in the above-mentioned procedure, so that a match from when 13 or 14 tiles to become initial tiles owned by the player are supplied (from the distributing of tiles) to when it is determined that the player or the opponent character of the first match completes a hand or none completes a hand (no hand is completed) is repeated until the point of the player or opponent character becomes zero or the player completes a hand 3 times.

In the process of step S311, playing result data including information concerning winning/losing in the match against the opponent character by the player, the point acquired by the player, and the number of completions of the opponent character are stored into the RAM 333.

After the process of step S311, the CPU 331 executes an attraction selecting process (step S312). In the attraction selecting process, it is determined whether the player wins over the opponent character in the first match or not. If the player wins, the favorability is set in 3 (high, middle, and low) stages according to the number of completions of the opponent character in the match. The favorability data concerning thus set favorability is stored into the RAM 333, and usual attractions are presented according to the favorability data stored in the RAM 333. This attraction selecting process is illustrated by FIG. 5 as in the first embodiment.

After the process of step S312, the CPU 331 determines the opponent character to play against in the second match by sampling (step S313). Specifically, using the random number generator 334, a random number is extracted from within the range of 0 to 3. With reference to this random number and the addresses respectively associated with the remaining 4 characters stored in the RAM 333 in step S310, the character to play against in the second match is selected, and a garment therefor is determined by sampling. Thereafter, as in the above, the CPU 331 erases the address corresponding to the character determined by step S313, and then stores the respective addresses related to the unplayed 3 characters into the RAM 333 in association with the random numbers of 0 to 2.

After the process of step S313, the CPU 331 executes a process concerning a match against the character selected for the second match (step S314). The process of step S314 is substantially the same as that of step S311 mentioned above except for the point of the opponent character, difficulty in the match, character properties, etc., and thus will not be explained. Also, processes concerning matches against characters in the third to fifth matches at steps S317, S320, and S322, which will be mentioned later, are substantially the same as the above-mentioned process of step S311 and thus will not be explained. While actions of the characters A to E are regulated by the control unit 330, mahjong skills of the characters A to E are set individually as mentioned above, so that the difficulty in completing a hand by the player and the like vary depending on the opponent characters.

After the process of step S314, the CPU 331 executes an attraction selecting process (step S315).

In this attraction selecting process, as in step S312, it is determined whether the player wins over the opponent character in the second match or not. If the player wins, the favorability is set in 3 (high, middle, and low) stages according to the number of completions by the opponent character in the match. The favorability data concerning thus set favorability is stored into the RAM 333, and usual attractions are presented according to the favorability data stored in the RAM 333.

Here, since the opponent character replaces that in the first match, usual attractions different from those in step S312 are carried out even at the same favorability (e.g., high favorability). For reducing the data volume, the same usual attractions may be carried out when the favorability is the same after changing the character.

In the attraction selecting processes in steps S318, S321, and S323 which will be explained later, their opponent characters differ from that in step S312, whereby usual attractions different from those in step S312 are presented even at the same favorability (e.g., high favorability). However, their processing methods are substantially the same as those of steps S312, S315 mentioned above, and thus will not be explained in the following.

After the process of step S315, the CPU 331 determines the opponent character for the third match by sampling (step S316). Specifically, using the random number generator 334, a random number is extracted from within the range of 0 to 2. With reference to this random number and the addresses respectively associated with the remaining 3 characters stored in the RAM 333 in step S313, the character to play against in the third match is selected, and a garment therefor is determined by sampling. Thereafter, as in the above, the CPU 331 erases the address corresponding to the character determined by step S316, and then stores the respective addresses related to the unplayed 2 characters into the RAM 333 in association with the random numbers of 0 to 1.

After the process of step S316, the CPU 331 executes a process concerning a match against the opponent character for the third match (step S317), and then an attraction selecting process (step S318).

After the process of step S318, the CPU 331 determines the opponent character to play against in the fourth match by sampling from the remaining 2 characters (step S319). Specifically, using the random number generator 334, a random number is extracted from within the range of 0 to 1. With reference to this random number and the addresses respectively associated with the remaining 2 characters stored in the RAM 333 in step S316, the character to play against in the fourth match is selected, and a garment therefor is determined by sampling. Thereafter, as in the above, the CPU 331 erases the address corresponding to the character determined by step S319, and then stores the address related to the remaining 1 character into the RAM 333.

After the process of step S319, the CPU 331 executes a process concerning a match against the opponent character for the fourth match (step S320), and then an attraction selecting process (step S321).

After the process of step S321, the CPU 331 executes a process concerning a match (fifth match) against the remaining 1 character stored in the RAM 333 (step S322), and then an attraction selecting process (step S323).

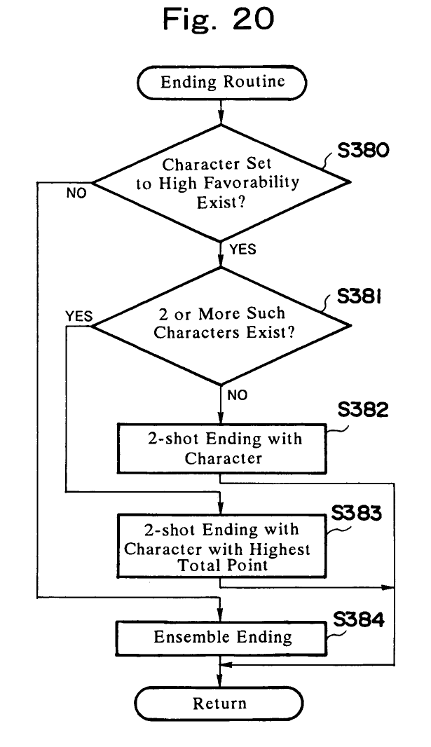

If the process of step S323 is executed, then the CPU 331 carries out an ending process (step S324). In the ending process, an image showing a 2-shot picture with one of the 5 opponent characters or a group picture of all the 5 characters and the player is displayed on the display device 313 according to the respective favorabilities set for the 5 opponent characters. The ending attraction process will later be explained in detail with reference to FIG. 20.

After executing the process of step S324, this subroutine is terminated.

During when the subroutine shown in FIG. 19 is executed, the control unit 330 functions as game control means which proceeds with the mahjong game according to control signals from the operating device 315.

The images shown in FIGS. 6A to 6C and 13A and 13B explained in the first embodiment are also displayed on the display device 313 of the mahjong game machine 310, and thus will not be explained here.

FIG. 20 is a flowchart showing an ending routine executed as being called at step S324 of the subroutine shown in FIG. 19.

First, the CPU 331 determines whether any opponent character with the high favorability exists or not (step S380). Namely, the CPU 331 refers to favorability data concerning the 5 opponent characters (characters A to E) stored in the RAM 333, and determines whether or not there is any opponent character whose favorability is set as high.

If it is determined in step S380 that there is an opponent character whose favorability is high, then the CPU 331 determines whether or not there are at least 2 opponent characters falling under this category (step S381). Namely, the CPU 331 refers to favorability data concerning the characters A to E stored in the RAM 333, and determines whether or not there are at least 2 opponent characters whose favorability is set as high.

If it is determined in step S381 that there are 2 or more opponent characters falling under this category, the CPU 331 presents 2-shot ending attractions with an opponent character against which the player acquired the highest total point in the matches among the opponent characters falling under this category and the player (step S383). In the process of step S383, an ending attraction data item concerning the 2-shot ending with the opponent character and the player is selected from a plurality of ending attraction data items stored in the ROM 332 and is set into the RAM 333, and ending attractions are presented according to thus set ending attraction data item.

If it is determined in step S381 that there is less than 2 opponent characters (only 1 opponent character) falling under this category, the CPU 331 presents 2-shot ending attractions with this opponent character and the player (step S382).

If it is determined in the above-mentioned step S380 that there is no opponent character whose favorability is set to high, then the ending attractions with all the opponent characters and the player are presented (step S388). In the process of step S388, an ending attraction data item concerning the ending attractions with all the characters is selected from a plurality of ending attraction data items stored in the ROM 332 and is set into the RAM 333, and ending attractions are presented according to thus set ending attraction data item.

After the process of step S382, S383, or S384 is executed, this subroutine is terminated.

During when the subroutine shown in FIG. 20 is executed, the control unit 330 functions as selecting means which selects, according to favorabilities of 5 opponent characters (characters A to E) in response to the winning over all the matches against the 5 opponent characters, an ending attraction data item as attraction data from a plurality of ending attraction data items stored in the ROM 332.

Also, during when the subroutine shown in FIG. 20 is executed, the control unit 330 functions as attraction means which presents ending attractions based on images and sounds according to the ending attraction data selected by the selecting means.

The mahjong game machine may comprise a printer so as to print out the attraction images shown in FIG. 20.

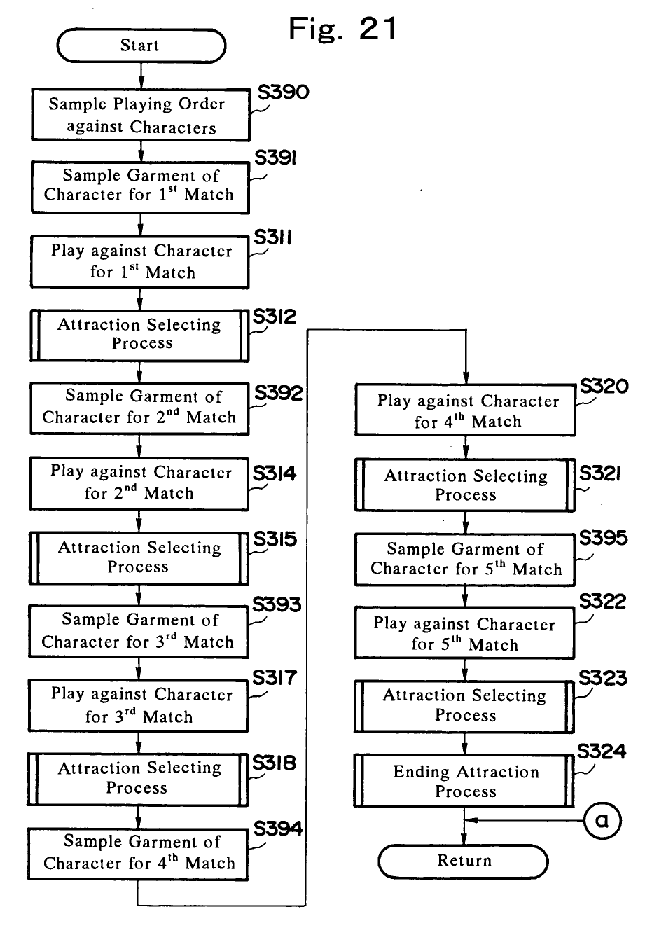

FIG. 21 represents a flowchart showing another example of subroutine executed in the mahjong game machine 310. In this subroutine, the order of playing against opponent characters is totally determined when starting a game. This subroutine is one executed as being called from a mahjong game machine control program which regulates a mahjong game of the mahjong game machine 310 executed beforehand when the player inserts a predetermined coin into the coin insertion slot 18 (see FIG. 1) and pushes the operating button 17f (see FIG. 2) of the operating device 315. Here, steps of the subroutine in FIG. 21 carrying out the same processes as those in FIG. 19 will be referred to with numerals identical thereto without repeating their detailed descriptions.

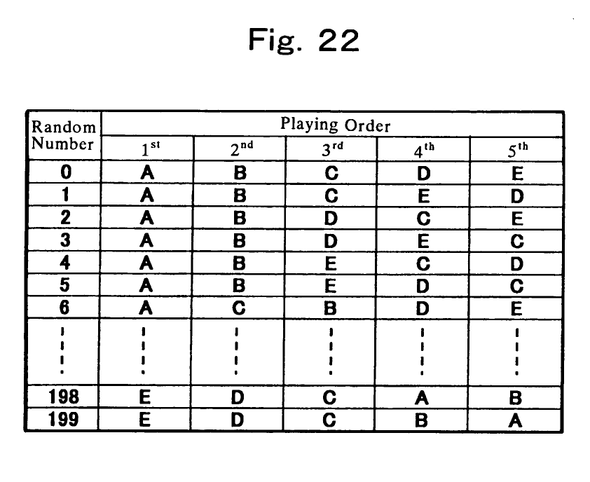

First, the CPU 331 determines the order of playing against the characters A to E by sampling (step S390). For example, according to an extracted random number, the playing order can be determined with reference to a character playing order sampling table which is shown in FIG. 22 and stored in the ROM 332. Specifically, the character playing order sampling table shown in FIG. 22 registers 120 playing orders associated with random numbers of 0 to 199, respectively. Using the random number generator 334, a random number is extracted from the range of 0 to 199. This random number is looked up in the table, whereby the playing order of characters A to E is determined. The CPU 331 manages thus determined playing order by storing it into the RAM 333. During when step S390 is executed, the control unit 330 functions as opponent character sampling means which determines opponent characters.

After executing the process of step S390, the CPU 331 samples a garment for the opponent character in the first match. Namely, the ROM 332 stores image data concerning a plurality of figures with respective garments for each character, whereas the CPU 331 determines which figure with a garment to appear as a character to play against in the first match by sampling using a random number and a sampling table (step S391).

During when the process of step S391 is executed, the control unit 330 functions as character garment sampling means which determines a garment of the opponent character. During when the processes of steps S392, S393, S394, and S395 which will be explained later are executed, the control unit 330 functions as character garment sampling means which determines a garment of the opponent character.

After the process of step S391, the CPU 331 executes a process concerning a match against the character determined by sampling in step S391 (step S311). Namely, the CPU 331 extracts the character image data determined by step S391 and executes a process concerning the match against this character.

After the process of step S311, the CPU 331 executes an attraction selecting process (step S312). Subsequently, for the character to play against in the second match, the CPU 331 determines a garment figure by sampling (step S392). This processing method can be carried out as with step S391. Steps S393, S394, and S395, which will be mentioned later, can also be carried out similarly and thus will not be explained in detail.

After the process of step S392, the CPU 331 executes a process concerning a match against the character determined by sampling in step S392 (step S314). Namely, the CPU 331 extracts the character image data determined by step S392 and executes a process concerning the match against this character.

After the process of step S314, the CPU 331 executes an attraction selecting process (step S315). Subsequently, for the character to play against in the third match, the CPU 331 determines a garment figure by sampling (step S393).

After the process of step S393, the CPU 331 executes a process concerning a match against the character determined by sampling in step S393 (step S317). Namely, the CPU 331 extracts the character image data determined by step S393 and executes a process concerning the match against this character.

After the process of step S317, the CPU 331 executes an attraction selecting process (step S318). Subsequently, for the character to play against in the fourth match, the CPU 331 determines a garment figure by sampling (step S394).

After the process of step S394, the CPU 331 executes a process concerning a match against the character determined by sampling in step S394 (step S320). Namely, the CPU 331 extracts the character image data determined by step S394 and executes a process concerning the match against this character.

After the process of step S320, the CPU 331 executes an attraction selecting process (step S321). Subsequently, for the character to play against in the fifth match, the CPU 331 determines a garment figure by sampling (step S395).

After the process of step S395, the CPU 331 executes a process concerning a match against the character determined by sampling in step S395 (step S322). Namely, the CPU 331 extracts the character image data determined by step S395 and executes a process concerning the match against this character.

After the process of step S322, the CPU 331 executes an attraction selecting process (step S323). After the process of step S323, the CPU 331 executes an ending process (step S324).

After executing the process of step S324, this subroutine is terminated.

During when the subroutine shown in FIG. 19 is executed, the control unit 330 functions as game control means which proceeds with the mahjong game according to control signals from the operating device 315.

The fourth embodiment can randomly determine the order of playing against opponent characters by sampling, and thus can provide a mahjong game which the player can fully enjoy for a long time without being bored.

In the fourth embodiment, the playing order is determined before each time a match against an opponent character is played. This can provide a mahjong game having various additional gaming properties unlike a monotonous game of competing for a higher final point. For example, in the case of a mahjong game which is over when a predetermined game state, e.g., where the player's point becomes zero, is attained, opponent characters can be sampled and determined from specific opponent characters according to game results and game states such as the playing result history, the point of the player, and the continuance (number) of games.

The fourth embodiment can randomly determine the order of playing against opponent characters by sampling, and can randomly determine and display garments of the opponent characters, whereby the player can enjoy the mahjong game more without being bored.

In this specification, the “garment” refers to a concept broadly encompassing not only clothes but also, for example, hairstyles, accessories, hats, and makeup which are worn by a body.

When the game machine comprises an attachment detachably attaching thereto the storage means for allowing an electric connection, the storage means can detachably be attached to the attachment so as to allow an electric connection. This game machine can change the kinds of games played thereby by a quite easy and simple operation of attaching/detaching storage means storing different kinds of game programs to/from the attachment, and allow various kinds of games to play at a very low cost.

What is claimed is:

1. A confrontation game machine with which a player plays against a character in a game,
the game machine comprising:
a storage device which stores a plurality of items of attraction data concerning attractions presented in response to a win over the character and/or data specifying a plurality of characters to play against in the game;
a display device which displays an opponent character stored in the storage device; and
a selecting device which functions to select one item of attraction data from the plurality of items of attraction data stored in the storage device and/or to select in an order of playing against the player the data specifying the plurality of characters stored in the storage device.

2. A mahjong game machine comprising:
a display device which displays at least images of a tile owned by a player and a tile discarded thereby and a tile discarded by an opponent character played against in a game;
a game control device which proceeds with a mahjong game according to at least a control signal from an operating device;
an attraction data storage device which stores a plurality of items of attraction data associated with a result of winning/losing of the game;
a selecting device which selects according to the result of winning/losing of the game one item of attraction data from the plurality of items of attraction data stored in the attraction data storage device; and
an attraction device which causes the display device to carry out an attraction at least with an image according to the item of attraction data selected by the selecting device.

3. A mahjong game machine which provides a mahjong game in which a player plays against a plurality of opponent characters in a game, the game machine comprising:
a display device which displays at least images of a tile owned by a player and a tile discarded thereby and a tile discarded by the opponent characters;
a game control device which proceeds with a mahjong game according to at least a control signal from an operating device;
an attraction data storage device which stores a plurality of items of attraction data concerning attractions presented in response to wins over the opponent characters;
a selecting device which selects according to a result of playing against an opponent character in response to a win over the opponent character one item of attraction data from the plurality of items of attraction data stored in the attraction data storage device; and
an attraction device which presents an attraction based on an image and/or sound according to the item of attraction data selected by the selecting device.

4. A mahjong game machine according to claim 3, wherein the mahjong game is a two-player mahjong game played by two players in one game.

5. A mahjong game machine according to claim 3, wherein the attraction data includes a plurality of items of ending attraction data concerning a plurality of ending attractions presented in response to wins over all the plurality of opponent characters; and
wherein the selecting device selects one item of ending attraction data from the plurality of items of ending attraction data in response to wins over all the plurality of opponent characters.

6. A mahjong game machine according to claim 3, wherein the playing result is at least one item of information concerning winning/losing in a match against the opponent character, a point acquired by the player in the match against the opponent character, and a number of completions by the opponent character.

7. A mahjong game machine according to claim 3, wherein, upon winning over the opponent character, favorability information is set to any of a plurality of stages of levels according to a number of completions by the opponent character in the match.

8. A mahjong game machine according to claim 7, wherein the ending attraction is configured such that the display device displays an image of a two-shot picture of the player with one of the plurality of opponent characters or a group picture of the plurality of opponent characters and the player according to favorability information items respectively set for the plurality of opponent characters.

9. A mahjong game machine according to claim 3, wherein an image showing a figure of the opponent character and an image showing a line spoken by the opponent character are displayed on a screen of the display device.

10. A mahjong game machine according to claim 3, further comprising a printer which prints out an attraction image displayed on the display device by the attraction device.

11. A mahjong game machine control program which causes a mahjong game machine comprising a display device which displays at least images of a tile owned by a player and a tile discarded thereby and a tile discarded by an opponent character and which provides a two-player mahjong game in which a player plays against a plurality of opponent characters to function as:
a game control device which proceeds with the mahjong game according to at least a control signal from an operating device;
an attraction data storage device which stores a plurality of items of attraction data concerning attractions presented in response to wins over the opponent characters;
a selecting device which selects according to a result of playing against an opponent character in response to a win over the opponent character one item of attraction data from the plurality of items of attraction data stored in the attraction data storage device; and
an attraction device which presents an attraction based on an image and/or sound according to the item of attraction data selected by the selecting device.

12. A mahjong game machine control program according to claim 11, wherein the attraction includes a plurality of items of ending attraction data concerning a plurality of ending attractions presented in response to wins over all the plurality of opponent characters; and
wherein the selecting device selects one item of ending attraction data from the plurality of items of ending attraction data in response to wins over all the plurality of opponent characters.

13. A mahjong game machine comprising:
a display device which displays at least images of a tile owned by a player and a tile discarded thereby and a tile discarded by an opponent character played against in a game;
a game control device which executes a game program concerning a mahjong game according to a control signal from an operating device operated by the player and which calculates a result of winning/losing of the mahjong game;
an attraction data storage device which stores a plurality of items of attraction data associated with results of winning/losing by the game control device;
a selecting device which selects according to the result of winning/losing calculated by the game control device one item of attraction data from the plurality of items of attraction data stored in the attraction data storage device; and
an attraction device which causes the display device to present an attraction by an image according to the item of attraction data selected by the selecting device.

14. A mahjong game machine according to claim 13, wherein the result of winning/losing is a result of playing against a plurality of opponent characters played against in the mahjong game;
wherein the mahjong game machine comprises a playing result storage device which cumulatively stores the result of playing as playing result data from when any of the player and the opponent characters completes a hand; and
wherein the selecting device extracts, according to a plurality of items of results of playing cumulatively stored in the playing result storage device, an item of attraction data for displaying a specific character in the plurality of characters, and causes the display device to display the specific character.

15. A mahjong game machine according to claim 14, further comprising a point calculating device which carries out a subtraction or addition of points of the player or opponent characters according to the result of winning/losing;
wherein, from when the points calculated by the point calculating device becomes minus, the selecting device selects the attraction data, and the attraction device displays and executes an ending attraction.

16. A mahjong game machine according to claim 13, wherein the playing result is at least one item of information concerning winning/losing in a match against the opponent character, a point acquired by the player in the match against the opponent character, and a number of completions by the opponent character.

17. A mahjong game machine according to claim 13, wherein, upon winning over the opponent character, favorability information is set to any of a plurality of stages of levels according to a number of completions by the opponent character in the match.

18. A mahjong game machine according to claim 15, wherein the ending attraction is configured such that the display devices display an image of a two-shot picture of the player with one of the plurality of opponent characters or a group picture of the plurality of opponent characters and the player according to favorability information items respectively set for the plurality of opponent characters.

19. A mahjong game machine according to claim 13, wherein an image showing a figure of the opponent character and an image showing a line spoken by the opponent character are displayed on a screen of the display device.

20. A mahjong game machine according to claim 13, further comprising a printer which prints out an attraction image displayed on the display device by the attraction device.

21. A mahjong game machine control program which causes a mahjong game machine comprising a display device which displays at least images of a tile owned by a player and a tile discarded thereby and a tile discarded by an opponent character played against in a game to function as:
a game control device which executes a game program concerning a mahjong game according to a control signal from an operating device operated by the player and which calculates a result of winning/losing of the mahjong game;
an attraction data storage device which stores a plurality of items of attraction data associated with the result of winning/losing calculated by the game control device;
a selecting device which selects according to the result of winning/losing calculated by the game control device one item of attraction data from the plurality of attraction data stored in the attraction data storage device; and
an attraction device which presents an attraction based on an image and/or sound according to the item of attraction data selected by the selecting device.

22. A mahjong game machine control program according to claim 21, wherein the result of winning/losing is a result of playing against a plurality of opponent characters to play against in a game; and
wherein the mahjong game machine control program functions as a playing result storage device which cumulatively stores the result of playing as playing result data from when any of the player and the opponent characters completes a hand, and
functions, according to a plurality of items of results of playing cumulatively stored in the playing result storage device, to cause the selecting device to extract an item of attraction data for displaying a specific character in the plurality of characters, and cause the display device to display the specific character.

23. A mahjong game machine control program according to claim 22, further functioning as a point calculating device which carries out a subtraction or addition of a point of the player or opponent characters according to the result of winning/losing; and
wherein, from when the point calculated by the point calculating device becomes minus, the selecting device functions to select the attraction data, and the attraction device functions to display and execute an ending attraction.

24. A game machine comprising a storage device which stores at least a plurality of items of data specifying a plurality of opponent characters to play against in a game;
a display device which displays the opponent characters stored in the storage device; and
a selecting device which selects according to an order of playing with the player the data specifying the plurality of characters stored in the storage device.

25. A game machine comprising:
a storage device which stores a plurality of kinds of image data of opponent characters to play against in a game, and results of playing against the opponent characters classified into a plurality of evaluation levels beforehand;
a display device which displays an opponent character stored in the storage device;
an operating device which inputs an instruction from the player during a play against the opponent character displayed by the display device;
a display control device which successively displays on the display device the opponent characters replaced according to the evaluation levels based on the results of playing;
a temporary storage device which temporarily stores data of the result of playing against the opponent character by the player;
a comparing device which compares the result of playing temporarily stored in the temporary storage device with the evaluation levels stored in the storage device; and
a selecting device which selects from the plurality of types of opponent characters an opponent character to be displayed as a replacement on the display device according to a result of comparison by the comparing device.

26. A game machine according to claim 25, wherein the game machine is a mahjong game machine.

27. A game machine according to claim 25, wherein the game machine is a chess or go game machine.

28. A game machine according to claim 25, wherein the playing result is at least one item of information concerning winning/losing in a match against the opponent character, a point acquired by the player in the match against the opponent character, and a number of completions by the opponent character.

29. A game machine according to claim 25, wherein the selecting device selects according to data of playing results against the opponent character so far a playing order pattern from a plurality of kinds of playing order patterns against the opponent character stored beforehand in the storage device.

30. A game machine according to claim 25, wherein, upon winning over the opponent character, favorability information is set to any of a plurality of stages of levels according to a number of completions by the opponent character in the match.

31. A game machine according to claim 30, wherein the display device displays an image of a two-shot picture of the player with one of the plurality of opponent characters or a group picture of the plurality of opponent characters and the player according to favorability information items respectively set for the plurality of opponent characters.

32. A game machine according to claim 25, wherein an image showing a figure of the opponent character and an image showing a line spoken by the opponent character are displayed on a screen of the display device.

33. A mahjong game machine according to claim 25, further comprising a printer which prints out an attraction image displayed on the display device by the attraction device.

34. A game machine control program which causes a game machine comprising a display control device which successively displays on a display device a plurality of types of opponent characters to play against in a game replaced according to an evaluation level based on a result of playing, and a temporary storage device which temporarily stores a result of playing against an opponent character by a player to function as
a comparing device which compares the result of playing temporarily stored in the temporary storage device with the evaluation level stored in the storage device; and
a selecting device which selects from the plurality of types of opponent characters an opponent character to be displayed as a replacement on the display device according to a result of comparison by the comparing device.

35. A mahjong game machine providing a mahjong game in which a player can successively play against a plurality of opponent characters, the mahjong game machine comprising:
a display device which displays at least images of a tile owned by the player and a tile discarded thereby and a tile discarded by an opponent character played against in the game; and
an opponent character sampling device which determines by sampling an order of playing against the plurality of opponent characters.

36. A mahjong game machine according to claim 35, wherein the opponent character sampling device determines an opponent from remaining unplayed opponent characters at each match.

37. A mahjong game machine according to claim 35, further comprising a character garment sampling device adapted to cause the display device to display the plurality of opponent characters as a plurality of images with different garments, respectively, and determine by sampling which opponent character with a garment to display.

38. A mahjong game machine according to claim 35, wherein the playing result is at least one item of information concerning winning/losing in a match against the opponent character, a point acquired by the player in the match against the opponent character, and a number of completions by the opponent character.

39. A mahjong game machine according to claim 35, wherein, upon winning over the opponent character, favorability information is set to any of a plurality of stages of levels according to a number of completions by the opponent character in the match.

40. A mahjong game machine according to claim 39, wherein the display device displays an image of a two-shot picture of the player with one of the plurality of opponent characters or a group picture of the plurality of opponent characters and the player according to favorability information items respectively set for the plurality of opponent characters.

41. A mahjong game machine according to claim 35, wherein an image showing a figure of the opponent character and an image showing a line spoken by the opponent character are displayed on a screen of the display device.

42. A mahjong game machine according to claim 35, further comprising a printer which prints out an attraction image displayed on the display device by the attraction device.

43. A mahjong game machine according to claim 35, wherein the opponent character sampling device comprises a random number generator.

44. A mahjong game machine control program which causes a mahjong game machine providing a mahjong game in which a player can successively play against a plurality of opponent characters, the mahjong game machine comprising a display device which displays at least images of a tile owned by the player and a tile discarded thereby and a tile discarded by an opponent character played against in the game to function as
an opponent character sampling device which determines by sampling an order of playing against the plurality of opponent characters.

45. A mahjong game machine providing a mahjong game in which a player plays against a plurality of opponent characters in a game, the game machine comprising:
display means for displaying at least images of a tile owned by a player and a tile discarded thereby and a tile discarded by the opponent characters;
game control means for proceeding with a mahjong game according to at least a control signal from operating means;
attraction data storage means for storing a plurality of items of attraction data concerning attractions presented in response to wins over the opponent characters;
selecting means for selecting according to a result of playing against an opponent character in response to a win over the opponent character one item of attraction data from the plurality of items of attraction data stored in the attraction data storage means; and
attraction means for presenting an attraction based on an image and/or sound according to the item of attraction data selected by the selecting means.

46. A mahjong game machine control program which causes a mahjong game machine comprising display means for displaying at least images of a tile owned by a player and a tile discarded thereby and a tile discarded by an opponent character, and providing a two-player mahjong game in which a player plays against a plurality of opponent characters to function as:
game control means for proceeding with the mahjong game according to at least a control signal from operating means;
attraction data storage means for storing a plurality of items of attraction data concerning attractions presented in response to wins over the opponent characters;
selecting means for selecting according to a result of playing against an opponent character in response to a win over the opponent character one item of attraction data from the plurality of items of attraction data stored in the attraction data storage means; and
attraction means for presenting an attraction based on an image and/or sound according to the item of attraction data selected by the selecting means.

47. A mahjong game machine comprising:
display means for displaying at least images of a tile owned by a player and a tile discarded thereby and a tile discarded by an opponent character played against in a game;
game control means for executing a game program concerning a mahjong game according to a control signal from operating means operated by the player, and calculating a result of winning/losing of the mahjong game;
attraction data storage means for storing a plurality of items of attraction data associated with results of winning/losing by the game control means;
selecting means for selecting according to the result of winning/losing calculated by the game control means one item of attraction data from the plurality of items of attraction data stored in the attraction data storage means; and
attraction means for causing the display means to present an attraction by an image according to the item of attraction data selected by the selecting means.

48. A mahjong game machine control program which causes a mahjong game machine comprising display means for displaying at least images of a tile owned by a player and a tile discarded thereby and a tile discarded by an opponent character played against in a game to function as:
game control means for executing a game program concerning a mahjong game according to a control signal from operating means operated by the player, and calculating a result of winning/losing of the mahjong game;
attraction data storage means for storing a plurality of items of attraction data associated with the result of winning/losing calculated by the game control means;
selecting means for selecting according to the result of winning/losing calculated by the game control means one item of attraction data from the plurality of attraction data stored in the attraction data storage means; and
attraction means for presenting an attraction based on an image and/or sound according to the item of attraction data selected by the selecting means.

49. A game machine comprising:
storage means for storing a plurality of kinds of image data of opponent characters to play against in a game, and results of playing against the opponent characters classified into a plurality of evaluation levels beforehand;
display means for displaying an opponent character stored in the storage means;
operating means for inputting an instruction from the player during a play against the opponent character displayed by the display means;
display control means for successively displaying on the display means the opponent characters replaced according to the evaluation levels based on the results of playing;
temporary storage means for temporarily storing data of the result of playing against the opponent character by the player;
comparing means for comparing the result of playing temporarily stored in the temporary storage means with the evaluation levels stored in the storage means; and
selecting means for selecting from the plurality of types of opponent characters an opponent character to be displayed as a replacement on the display means according to a result of comparison by the comparing means.

50. A game machine control program which causes a game machine comprising display control means for successively displaying on display means a plurality of types of opponent characters to play against in a game replaced according to an evaluation level based on a result of playing, and temporary storage means for temporarily storing a result of playing against an opponent character by a player to function as:
comparing means for comparing the result of playing temporarily stored in the temporary storage means with the evaluation level stored in the storage means; and
selecting means for selecting from the plurality of types of opponent characters an opponent character to be displayed as a replacement on the display means according to a result of comparison by the comparing means.

51. A mahjong game machine providing a mahjong game in which a player can successively play against a plurality of opponent characters, the mahjong game machine comprising:
display means for displaying at least images of a tile owned by the player and a tile discarded thereby and a tile discarded by an opponent character played against in the game; and
opponent character sampling means for determining by sampling an order of playing against the plurality of opponent characters.

52. A mahjong game machine control program which causes a mahjong game machine providing a mahjong game in which a player can successively play against a plurality of opponent characters and comprising display means for displaying at least images of a tile owned by the player and a tile discarded thereby and a tile discarded by an opponent character played against in the game to function as
opponent character sampling means for determining by sampling an order of playing against the plurality of opponent characters.
